(19) United States
(12) Patent Application Publication
(10) Pub. No.: US 2026/0289302 A1
(43) Pub. Date: Sep. 24, 2026

(54) SYSTEM

(71) Applicant: SoftBank Group Corp., Tokyo (JP)

(72) Inventor: Takeshi OGAWA, Tokyo (JP)

(73) Assignee: SoftBank Group Corp., Tokyo (JP)

(21) Appl. No.: 19/567,078

(22) Filed: Mar. 14, 2026

(30) Foreign Application Priority Data
Mar. 19, 2025 (JP) 2025-045013

(51) Int. Cl. G06N 3/08; G06N 3/0455; H04L 51/02

(52) U.S. Cl. CPC G06N 3/08; G06N 3/0455; H04L 51/02

(57) ABSTRACT

A system includes a processor that is configured to acquire legal information of laws and regulations from databases of laws and regulations around the world and learn the acquired legal information, generate a prompt sentence for instructing a generative AI model to generate a bill based on a goal of a user, and input the prompt sentence into the generative AI model and obtain the bill generated by the generative AI model.

### CROSS-REFERENCE TO RELATED APPLICATION

This application is based on and claims priority under 35 USC 119 from Japanese Patent Application No. 2025-045013 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for drafting legislative bills rely heavily on manual work by legislators and legal experts, who must review large volumes of existing laws and regulations, check for consistency, and iteratively revise draft texts based on policy goals and stakeholder feedback. As the body of legislation grows and becomes increasingly complex at both domestic and international levels, it becomes difficult for a human drafter to comprehensively understand relevant laws and regulations from multiple jurisdictions, to promptly generate bill drafts that are aligned with a given legislative goal, and to ensure that such bill drafts do not contradict existing laws and regulations. Furthermore, existing systems that merely provide document search or template-based drafting support do not sufficiently enable automatic generation of bills tailored to a user's specific goal, nor do they adequately support automatic detection and elimination of contradictions with existing laws and regulations or iterative refinement of drafts based on user feedback. Therefore, there is a need for a system that can, on the basis of legal information acquired from databases of laws and regulations around the world, automatically generate a bill consistent with a user's goal by using a generative AI model, automatically compare the generated bill with existing laws and regulations to detect and eliminate contradictions, and further generate revised bills in response to user feedback.

### SUMMARY

In order to solve the above-described problems, according to one aspect of the present invention, there is provided a system comprising a processor, wherein the processor is configured to acquire legal information of laws and regulations from databases of laws and regulations around the world and learn the acquired legal information, generate a prompt sentence for instructing a generative AI model to generate a bill based on a goal of a user, and input the prompt sentence into the generative AI model and obtain the bill generated by the generative AI model. In this manner, the system enables automatic generation of a bill that reflects the user's goal while being informed by learned legal information. In one embodiment, the processor is further configured to compare the generated bill with existing laws and regulations, detect contradictions between the generated bill and the existing laws and regulations, and eliminate the detected contradictions, thereby allowing the system to provide a bill that is harmonized with the current legal framework. In another embodiment, the processor is further configured to receive feedback from the user and generate a revised bill by using the generative AI model again based on the feedback, so that the system can iteratively refine the bill in response to user evaluations, policy adjustments, or additional constraints. Through these means, the system can efficiently support the entire drafting process from initial bill generation to consistency checking and iterative revision.
The term “system” refers to an arrangement including at least one processor and one or more associated storage devices, communication interfaces, and/or execution environments configured to perform the functions described in the claims.
The term “processor” refers to one or more hardware processing units, such as a central processing unit (CPU), a graphics processing unit (GPU), or another computing device, configured to execute instructions to perform the processing described in the claims.
The term “legal information” refers to textual or structured data representing laws, regulations, ordinances, statutes, or similar normative legal provisions, including titles, articles, sections, and associated metadata.
The term “laws and regulations” refers to binding legal rules enacted or issued by legislative bodies, governmental agencies, or other competent authorities, including statutes, regulations, ordinances, and similar normative acts.
The term “databases of laws and regulations” refers to one or more electronic data repositories that store legal information pertaining to laws and regulations and that can be accessed by the processor via a communication network or local storage.
The term “learn” refers to processing legal information by using techniques such as natural language processing, statistical analysis, or machine learning, so that the processor or an associated model can represent, classify, compare, or otherwise utilize the content of the legal information for subsequent tasks.
The term “goal of a user” refers to a legislative objective, policy intention, or desired outcome specified by the user in natural language or structured form, which serves as a basis for generating a bill.
The term “prompt sentence” refers to a text string or set of text strings generated by the processor and provided as input to a generative AI model to instruct the generative AI model to generate a bill that reflects the goal of the user.
The term “generative AI model” refers to a computational model, such as a large language model or other generative machine learning model, that is configured to generate new text, including legislative bill text, in response to input data such as a prompt sentence.
The term “bill” refers to a draft legislative document, including provisions such as titles, purposes, definitions, articles, sections, and clauses, which is intended to be proposed for enactment as a law or regulation.
The term “existing laws and regulations” refers to laws and regulations that are already in force or officially enacted at the time of comparison with the generated bill.
The term “contradictions” refers to inconsistencies, conflicts, or mutually incompatible provisions between the generated bill and existing laws and regulations, including contradictory definitions, obligations, permissions, prohibitions, or procedures.
The term “eliminate the detected contradictions” refers to modifying, deleting, or otherwise adjusting portions of the generated bill so that the contradictions with existing laws and regulations are resolved or reduced to an acceptable level.
The term “feedback from the user” refers to information provided by the user regarding an evaluation, correction, preference, revision request, or additional condition related to a previously generated bill.
The term “revised bill” refers to a bill that has been generated or regenerated by the generative AI model based on feedback from the user, such that the bill reflects one or more changes requested by the user or inferred from the feedback.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

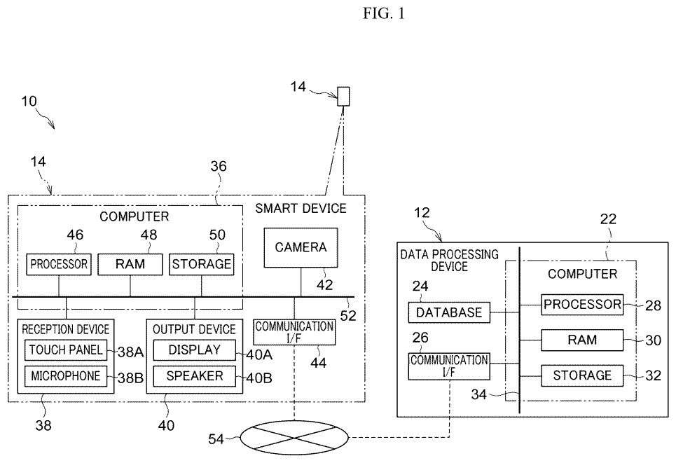

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

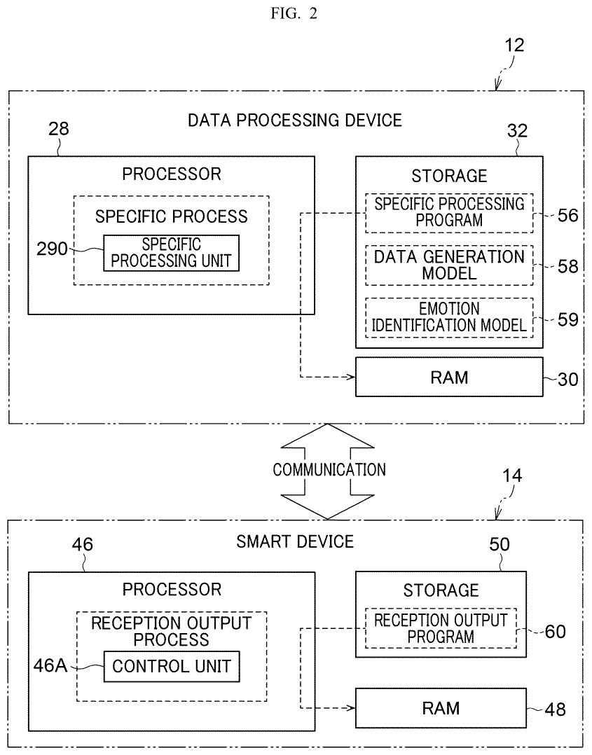

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented legal information systems primarily retrieve and display statutory text or perform simple keyword-based matching. Such systems suffer from several technical shortcomings when operating at scale on heterogeneous legal corpora distributed across multiple regions. First, conventional database and search components are not configured to convert unstructured regulation text into machine-usable linguistic feature information, such as sentence structures and semantic relationships, in a way that can be efficiently reused across different downstream processes. As a result, the systems repeatedly perform fragmented parsing and search operations, increasing processor load, memory consumption, and latency, particularly when handling complex user queries involving multiple jurisdictions and interdependent provisions.
Second, conventional systems generally do not maintain an integrated trained model that simultaneously represents both contents and mutual relationships of regulation information. Instead, they rely on ad hoc rule sets or independent models that do not share a common representation space. This fragmentation complicates the internal data flow between retrieval, analysis, and generation components, and limits the ability of the system to provide coherent and consistent machine-generated regulation proposals in response to user input.
Third, when a generative model is used merely as an external component that receives raw text or lightly pre-processed text, the host system has little control over the internal context used by the model. Context selection is often performed in a heuristic or manual manner, rather than through a technical pipeline that embeds both user prompt sentences and regulation segments into a shared feature space. Consequently, the generated proposals may exhibit internal inconsistency, poor relevance to the applicable regulations, and unstable quality, which in turn requires additional human post-processing and degrades overall system efficiency.
Fourth, existing systems generally perform comparison between generated proposals and existing regulations using straightforward text matching. Such comparison is not optimized to leverage linguistic feature information and trained models to detect deeper semantic inconsistencies, such as conflicts in obligations, time scopes, or cross-references. As a result, inconsistency detection tends to be either incomplete or computationally expensive, causing delays when the system processes large, frequently updated regulation databases.
Fifth, conventional feedback handling is usually restricted to simple rating or acceptance/rejection logs. These logs are rarely integrated into a technical feedback loop that modifies both the generative model and the underlying trained model in a structured and automated manner. Because of this, the system cannot efficiently adapt to user evaluation at scale, and must often retrain models from scratch or rely on manual tuning, which is computationally inefficient and does not fully exploit available processor and memory resources.

Accordingly, there is a need for a computer-implemented system that technically improves the way processors acquire, structure, and index regulation information; extract and reuse linguistic feature information; construct and use trained models representing regulation contents and relationships; generate and contextually constrain prompt sentences for a generative model; perform harmonization between generated proposals and existing regulations using feature-level comparison; and incorporate user feedback into iterative retraining. The technical problems to be solved thus include reducing processing redundancy and latency, stabilizing and improving the quality and consistency of generated regulation proposals, and enabling scalable and automated adaptation of the system based on user interactions, all by improving the internal operation of the computing system itself.

The specific processing by the specific processing unit 290 of the data processing device 12 in Example 1 is realized by the following means.

The present invention provides a server comprising a processor and a memory storing instructions which, when executed by the processor, cause the server to acquire regulation information corresponding to a plurality of regions from a storage device, structure the acquired regulation information into a normalized internal representation, and store the structured regulation information; to execute natural language processing on the acquired regulation information to extract linguistic feature information including terms, phrases, sentence structures, and semantic information, and to store the linguistic feature information as an index structure that is reusable across subsequent processing; to train, by performing machine learning processing based on the extracted linguistic feature information and the regulation information, a generative information processing model and construct a trained model that represents contents and mutual relationships of the regulation information; to generate, based on objective information input from a user and the trained model, a prompt sentence for causing the generative information processing model to generate a regulation proposal, to input the prompt sentence and related regulation information as contextual input to the generative information processing model, and to acquire the regulation proposal output from the generative information processing model; to compare the regulation proposal with the regulation information based on the linguistic feature information and the trained model, detect inconsistent elements in the regulation proposal, and harmonize the regulation proposal by deleting or correcting the inconsistent elements; and to acquire evaluation information from the user and retrain at least one of the generative information processing model and the trained model based on the evaluation information and a relationship between the regulation proposal and the regulation information so as to generate a revised regulation proposal. This enables an improvement of computer functionality by optimizing internal data representations and model interactions, reducing redundant parsing and comparison operations, decreasing response latency for complex multi-jurisdictional queries, stabilizing the relevance and internal consistency of machine-generated regulation proposals, and providing a technical feedback loop that automatically adapts and refines the models based on user interactions, thereby enhancing overall efficiency and capability of the legal information processing system.
The term “regulation information” refers to electronic data representing normative rules, including but not limited to statutes, ordinances, regulations, guidelines, and related provisions, which are stored in a computer-readable form and are associated with one or more regions or jurisdictions.
The term “storage device” refers to a hardware component or subsystem, such as a magnetic disk, solid-state drive, optical medium, or semiconductor memory, that persistently or semi-persistently stores computer-readable data.
The term “structured regulation information” refers to regulation information that has been converted from raw text or heterogeneous formats into a normalized internal representation, including associated identifiers, metadata, segmentation into units such as sections or articles, and logical relationships, in a form suitable for machine processing.
The term “normalized internal representation” refers to a data structure in which input information is converted into a standardized format, including standardized encoding, field organization, and segmentation rules, enabling consistent processing by multiple software components.
The term “natural language processing” refers to automated computational processing of text or speech in human language, including operations such as tokenization, part-of-speech tagging, lemmatization, syntactic parsing, semantic analysis, and named-entity recognition.
The term “linguistic feature information” refers to data derived from natural language processing that characterizes text at multiple levels, including detected terms and phrases, grammatical structures, semantic relations, entity annotations, and other features that describe the linguistic content of the text.
The term “index structure” refers to an organized data structure, such as an inverted index, hash table, tree structure, or vector index, that associates keys or features with locations of stored data to enable efficient search, retrieval, or matching.
The term “generative information processing model” refers to a machine learning model configured to produce new sequences of data, such as natural language text, based on learned probability distributions or patterns from training data, and to output candidate regulation proposals or explanations in response to input.
The term “trained model” refers to a machine learning model whose parameters have been adjusted through a training process using training data, such that the model represents patterns, relationships, or semantics of the training data, including contents and mutual relationships of regulation information.
The term “machine learning processing” refers to a computational training procedure in which a model's parameters are optimized using algorithms such as gradient-based optimization, based on input-output pairs or unlabeled data, to improve the model's performance on a defined task.
The term “objective information” refers to data indicating a user's goal or intent, including desired policy outcomes, constraints, focus topics, jurisdictions, or other requirements, which is provided as input for generating a regulation proposal.
The term “prompt sentence” refers to a sequence of natural language tokens or equivalent encoded input that instructs a generative information processing model to perform a specific task, such as generating a regulation proposal, explanation, or revision.
The term “regulation proposal” refers to machine-generated normative text or structured content that suggests new or modified rules, provisions, or clauses, based on regulation information and objective information.
The term “instruction sentence” refers to a natural language or encoded input sequence provided by a user that specifies a request, query, or command to be processed by the system, including but not limited to questions, modification requests, or generation instructions.
The term “input context” refers to auxiliary data, including selected regulation information, extracted features, or metadata, that is provided together with a prompt sentence to a generative information processing model to influence or constrain the model's output.
The term “response sentence” refers to natural language text generated by the system for presentation to a user, including explanations, summaries, or restatements of a regulation proposal or related regulation information.
The term “inconsistent elements” refers to portions of a regulation proposal that conflict with or fail to align with existing regulation information, including contradictions in obligations, scopes, temporal applicability, definitions, cross-references, or other legal relationships.
The term “harmonize the regulation proposal” refers to a process of modifying a regulation proposal by deleting, correcting, or otherwise adjusting inconsistent elements to improve coherence, compatibility, and alignment with existing regulation information.
The term “evaluation information” refers to data representing user feedback regarding one or more outputs of the system, including ratings, selections, corrections, annotations, or other indicators of quality, relevance, or adequacy of a regulation proposal.
The term “revised regulation proposal” refers to a regulation proposal that has been newly generated by the system after at least one retraining or adjustment of a generative information processing model or a trained model, taking into account evaluation information or updated regulation information.
The term “plurality of regions” refers to two or more distinct geographic or jurisdictional areas, such as countries, states, provinces, or administrative entities, for which separate sets of regulation information are maintained.
The term “contents and mutual relationships of the regulation information” refers to the substantive meaning of regulation provisions and the logical, temporal, hierarchical, and cross-referential connections among such provisions, including dependencies, exceptions, and cross-citations.
The term “user” refers to an individual or organizational entity that interacts with the system by providing input, such as objective information, instruction sentences, or evaluation information, and by receiving response sentences or regulation proposals.
The term “server” refers to one or more computing devices, including associated processors and memories, configured to provide data acquisition, processing, storage, and service functions to one or more client devices over a communication network.
The term “processor” refers to one or more hardware processing units, such as central processing units, graphics processing units, or dedicated accelerators, configured to execute instructions stored in a memory to perform the functions described for the system.

In one embodiment, a server cooperates with one or more terminals to implement a legal-information processing system as defined in the claims. The server includes at least one hardware processor, a main memory, a non-volatile storage device, and a network interface. The terminal includes at least one hardware processor, a memory, a local storage device, a display, and an input interface such as a keyboard or touchscreen. The server and the terminal execute software components including an operating system, a database management system, natural language processing libraries, and machine learning frameworks.

The server stores regulation information for a plurality of regions in one or more databases implemented by general-purpose database management software such as a relational database engine. The server stores each regulation as structured regulation information, in which the server represents the regulation by a normalized internal representation. The server, for example, represents each regulation as records containing fields for a jurisdiction identifier, a regulation identifier, an article identifier, a title string, a body text string, an effective date, and amendment metadata. The server also stores cross-reference information indicating references between articles and between regulations.

The server uses a database management system to store and retrieve the structured regulation information. The server, for example, uses a relational schema in which a regulation table stores basic regulation attributes, an article table stores article-level text segments, and a relation table stores cross-references and topic labels. The server indexes at least the article text and title fields using a text index and the jurisdiction and topic identifiers using a secondary index. By using a normalized internal representation and indices, the server reduces I/O overhead and improves query latency when the server later retrieves data for machine learning or user queries.

The server performs natural language processing on the article text using a natural language processing library such as a general-purpose tokenization and parsing library. The server loads the library into memory and executes functions that perform tokenization, part-of-speech tagging, lemmatization, dependency parsing, and named-entity recognition on the article text. The server creates linguistic feature information comprising, for each article, a sequence of tokens, associated part-of-speech tags, lemmas, dependency edges, and entity annotations. The server stores the linguistic feature information in a separate index structure, for example as JSON-like feature records keyed by article identifiers and stored in a feature table or a document index.

The server constructs an index structure for efficient search by mapping terms, phrases, and entity types to article identifiers. The server, for example, creates an inverted index in which each unique term in the regulation corpus is associated with a postings list of article identifiers and positions. The server also constructs a phrase index for multi-word expressions such as “personal data,” “minimum wage,” or “data controller,” using phrase detection rules and statistical thresholds on co-occurrence frequencies. By precomputing and storing these indices, the server reduces the computational cost of later search operations and enables the terminal to obtain relevant context rapidly for a generative AI model.

The terminal receives structured regulation information and linguistic feature information from the server over a communication network. The terminal stores received information into local storage, for example a file system or a lightweight database. The terminal preprocesses the regulation text and associated labels into machine learning training examples. The terminal, for example, creates supervised pairs in which an input sequence contains an article text plus metadata, and an output sequence contains a summary, an explanation, or a paraphrase indicating the function of the article. The terminal also configures unsupervised training examples by masking words or sentences and training the model to predict the masked content.

The terminal constructs a generative AI model as a neural network with a transformer architecture. The terminal includes an embedding layer that converts discrete tokens into dense numeric vectors, a plurality of self-attention blocks that compute attention weights between pairs of token positions, and feed-forward sublayers that apply nonlinear transformations. The terminal initializes the model using parameters from a general pretrained language model, and then fine-tunes the model on the regulation corpus. The terminal sets hyperparameters such as a hidden dimension, a number of attention heads, a number of layers, and a vocabulary size. The terminal defines an objective function such as cross-entropy loss between predicted token distributions and ground truth tokens.

The terminal executes a machine learning framework to train the generative AI model. The terminal, for example, uses a tensor computation library to perform matrix and tensor operations on a central processing unit, a graphics processing unit, or a specialized accelerator. The terminal repeatedly loads mini-batches of tokenized sequences into memory, computes forward passes through the transformer layers, and computes the loss. The terminal then computes gradients of the loss with respect to model parameters and updates the parameters using an optimization algorithm such as Adam. The terminal optionally applies regularization techniques such as dropout and learning rate scheduling to improve generalization. The terminal monitors validation loss and stops training when convergence is detected.

The terminal constructs a trained model that encodes both contents and mutual relationships of the regulation information. The terminal applies the trained model to generate vector embeddings for regulation segments by averaging or pooling the hidden states of the transformer at selected layers. The terminal stores these vector embeddings in a vector index data structure, such as a k-d tree or an approximate nearest neighbor index, in local storage or in the server. The terminal associates each vector with metadata including jurisdiction, regulation identifier, article identifier, and effective date. This indexing enables the terminal to perform semantic similarity search between user queries and regulation segments by computing distances such as cosine distance in the vector space.

The user interacts with a client application executing on the terminal. The user inputs objective information and a prompt sentence in natural language through an input field. The user, for example, inputs a prompt sentence such as “Please explain the main features of copyright law in the United States, including the duration of protection and fair use.” or “Tell me about France's data protection law.” or “Compare the minimum wage regulations in Germany and Japan as of 2023.” The user may also input more drafting-oriented prompt sentences such as “Draft an amendment proposal to strengthen penalties for data breaches under the current law in the United Kingdom, while keeping consistency with existing enforcement provisions.”

The terminal receives the prompt sentence and converts it into tokens using the same tokenizer as used for training the generative AI model. The terminal computes a query embedding by passing the tokenized prompt through the encoder portion of the generative AI model. The terminal performs a similarity search in the vector index to retrieve the most relevant regulation segments. The terminal may combine semantic similarity search with keyword-based filtering using the server's index structure, for example restricting candidates to a given jurisdiction or topic. By embedding both the prompt sentence and the regulation segments into a common vector space and using efficient approximate nearest neighbor search, the terminal reduces the time required to identify relevant context, compared to conventional full-text search alone.

The terminal constructs a model input sequence by concatenating a role specification such as “You are a legal information assistant,” the user's prompt sentence, and one or more retrieved regulation segments formatted as context. The terminal encodes this sequence into tokens and performs a forward pass through the generative AI model to compute output token probabilities. The terminal applies a decoding algorithm such as beam search or nucleus sampling to generate a regulation proposal or an explanatory response sentence. The terminal may impose constraints such as maximum length, avoidance of repetition, and inclusion of specific references by manipulating decoding scores based on token and phrase patterns.

The server or the terminal compares a generated regulation proposal with existing regulation information using both text-level and feature-level information. The server or the terminal aligns the proposal text with relevant articles using the vector index and keyword matches, then computes a measure of consistency based on detected entities, obligations, and time scopes. The server or the terminal, for example, parses the proposal with the natural language processing library, identifies obligations (subject, verb, object structures), compares them with obligations in existing regulations, and flags conflicts in conditions, thresholds, or effective dates. The server or the terminal classifies identified conflicts as inconsistent elements and either deletes or proposes modifications to those elements. Because this comparison uses precomputed linguistic feature information and the trained model's embeddings rather than simple string matching, the system detects deeper semantic inconsistencies with lower computational cost.

The terminal generates a response sentence for the user by reformulating the regulation proposal into natural language and including references to relevant regulations. The terminal formats the response into paragraphs and may insert markers for article numbers, jurisdiction names, and effective dates. The terminal then displays the response sentence and, optionally, the underlying citations on the terminal display. The user can visually inspect the generated text and its relation to existing regulation information without manually navigating through entire statutes.

The user supplies evaluation information by providing feedback via the client application. The user, for example, indicates whether the answer is helpful, correct, or complete, or marks specific sentences as problematic. The terminal encodes this feedback as evaluation information that associates the prompt sentence, the generated proposal, and the corresponding regulation segments with one or more quality labels or numerical ratings. The terminal stores this evaluation information in local storage and transmits it to the server periodically or in real time.

The terminal uses the evaluation information to retrain or fine-tune the generative AI model and the trained model. The terminal constructs additional training examples in which positive feedback strengthens patterns associated with accurate context selection and proposal generation, and negative feedback leads to gradient updates that penalize erroneous associations. The terminal reuses the same optimization algorithm and loss function, augmented by a term that incorporates the evaluation labels. Over time, the model parameters are adjusted such that the model becomes less likely to generate inconsistent or irrelevant proposals. Because the retraining process uses structured feedback and is integrated into the data flow, the system improves without requiring a complete manual redesign of rules.

In another embodiment, the server performs more of the heavy training and vector indexing work, while the terminal operates as a lighter-weight client. In such an embodiment, the server maintains the generative AI model and the vector index in a centralized computing environment with multiple processors and hardware accelerators. The terminal sends tokenized prompt sentences and context constraints to the server, and the server runs the transformer forward pass and decoding on dedicated hardware. This configuration enables the system to scale to large numbers of users while keeping latency low, because the server can batch multiple requests and exploit parallelism across processors and accelerators.

In a further embodiment, the system deploys different model variants for different tasks. The server maintains a larger generative AI model for high-accuracy legal drafting, and the terminal or server maintains a smaller encoder model specialized for fast embedding computation and semantic retrieval. The terminal selects which model to use based on the type of user request and the available hardware resources. This modular design allows the system to optimize computation time and energy consumption, by avoiding the use of an unnecessarily large model for simple retrieval tasks.

The system yields several technical effects beyond mere automation of human legal drafting. By converting raw regulation text into a normalized internal representation and precomputing linguistic feature information and vector embeddings, the server and the terminal reduce repeated parsing and search computations. This reduction leads to improved throughput and lower latency when handling complex, multi-jurisdictional queries. By embedding prompt sentences and regulations in a shared feature space and using vector indices, the terminal achieves faster and more accurate context selection than conventional keyword search, which directly improves the quality and stability of the outputs of the generative AI model.

The server and the terminal improve data management by maintaining a consistent linkage between structured regulation information, linguistic feature information, vector embeddings, and user feedback. This linkage enables traceable updates when regulations change, because the server can selectively retrain or update embeddings for affected regulations without reprocessing the entire corpus. The system also reduces communication load between the server and the terminal by transmitting structured identifiers and compressed embeddings instead of large raw text blocks when possible.

The generative AI model, trained and operated as described, processes regulation information according to rules and optimization criteria that differ from human manual drafting. The model applies attention mechanisms to compute context-dependent weights over all tokens in the input sequence, which allows it to capture long-range dependencies across different sections and regulations. The model's parameter updates follow a mathematically defined optimization path based on gradient descent and loss minimization, rather than subjective human judgment. These characteristics, together with the system's specialized data structures and training pipeline, cause the system to behave in a technically distinct manner from a human expert and produce improvements in speed, reproducibility, and consistency that would not be achievable by human effort alone at the same scale.

Through these structures and operations, the server, the terminal, and the user cooperate to implement the claimed system in a way that specifically improves computer functionality in the field of legal information processing, rather than merely performing a business method on a generic computer.

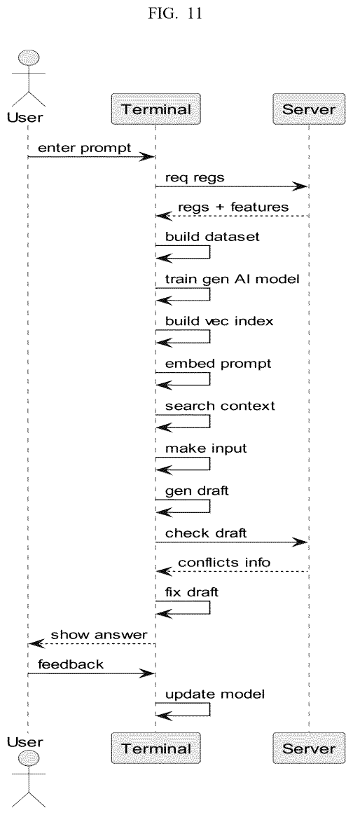

The following describes the processing flow using FIG. 11.

### Step 1:

The server acquires raw regulation information from a storage device. The server receives as input a query condition such as a list of regions, regulation types, and update timestamps, and executes database operations to read corresponding records from one or more regulation tables. The server performs data retrieval by issuing structured queries, loading results into memory, and validating encoding. The output of Step 1 is a collection of raw regulation records that include jurisdiction identifiers, regulation identifiers, article texts, and amendment metadata.

### Step 2:

The server structures the acquired regulation information into a normalized internal representation. The server receives as input the raw regulation records from Step 1 and performs data parsing, field mapping, and segmentation into logical units such as articles, sections, or paragraphs. The server converts heterogeneous formats into a unified schema, assigns unique identifiers to each segment, and normalizes text encoding. The output of Step 2 is structured regulation information stored as standardized records ready for further processing.

### Step 3:

The server generates linguistic feature information by applying natural language processing to the structured regulation information. The server receives as input the article-level text segments from Step 2 and executes tokenization, part-of-speech tagging, lemmatization, dependency parsing, and named-entity recognition using a natural language processing library. The server performs data operations that convert each text string into a sequence of tokens with associated tags and dependency edges. The output of Step 3 is linguistic feature information, including token sequences, grammatical structures, and entity annotations linked to corresponding article identifiers.

### Step 4:

The server builds and stores an index structure for efficient retrieval of regulation segments. The server receives as input the structured regulation information and the linguistic feature information from Steps 2 and 3 and performs index construction by computing term frequencies, phrase co-occurrences, and mappings from terms and phrases to article identifiers. The server creates and updates an inverted index and auxiliary maps keyed by jurisdiction, topic, and entity type. The output of Step 4 is an index structure that enables later keyword and feature-based search over the regulation corpus.

### Step 5:

The server provides structured regulation information and linguistic feature information to the terminal. The server receives as input a data request from the terminal specifying regions, topics, or regulation identifiers and uses the index structure and normalized records from previous steps to select relevant items. The server serializes the selected records and feature sets into a transmission format and sends this serialized data through a network interface. The output of Step 5 is a transmitted data package containing regulation segments and corresponding feature data, received by the terminal.

### Step 6:

The terminal stores the received regulation and feature data in local storage and prepares training examples. The terminal receives as input the serialized data package from Step 5 and performs deserialization, integrity checks, and insertion into a local database or file structure. The terminal processes the stored regulation segments to construct input-output pairs for training, such as mapping full article texts to short summaries or masked versions of the same text. The output of Step 6 is a training dataset composed of tokenizable sequences and associated labels or targets.

### Step 7:

The terminal tokenizes the training dataset and converts it into numerical tensors. The terminal receives as input the text-based training examples from Step 6 and applies a tokenizer associated with the generative AI model to segment text into tokens and map tokens to numeric identifiers. The terminal pads or truncates sequences to a specified length and packs them into batches. The output of Step 7 is a set of batched tensors representing input sequences and target sequences suitable for model training.

### Step 8:

The terminal initializes and trains the generative AI model using machine learning processing. The terminal receives as input the batched tensors from Step 7 and model configuration parameters such as number of layers, hidden size, and learning rate. The terminal executes forward passes through the model's embedding layer, attention blocks, and feed-forward layers to compute predicted token distributions, then computes a loss value such as cross-entropy between predictions and targets. The terminal calculates gradients by backpropagation and updates model weights using an optimization algorithm. The output of Step 8 is a trained generative AI model with updated parameters that encode patterns and relationships in the regulation information.

### Step 9:

The terminal generates vector embeddings for regulation segments using the trained model. The terminal receives as input the regulation segments and the trained generative AI model from Step 8, and it passes the tokenized regulation text through the model's encoder or hidden layers without performing decoding. The terminal computes fixed-length vector representations by applying pooling operations over hidden states, such as averaging or selecting the final hidden state. The output of Step 9 is a set of vector embeddings associated with regulation segment identifiers.

### Step 10:

The terminal builds a semantic index of regulation segments based on vector embeddings. The terminal receives as input the vector embeddings from Step 9 and performs index construction by inserting each embedding into a vector index data structure that supports similarity queries. The terminal may apply dimensionality reduction or clustering to improve search efficiency. The output of Step 10 is a semantic index that allows rapid retrieval of regulation segments based on similarity between vector embeddings.

### Step 11:

The user inputs a prompt sentence and objective information through the terminal interface. The user provides as input a natural language request such as “Please explain the main features of copyright law in the United States, including the duration of protection and fair use.” or “Tell me about France's data protection law.” or “Compare the minimum wage regulations in Germany and Japan as of 2023.” The terminal receives this text along with optional parameters indicating jurisdictions or topics. The output of Step 11 is a stored prompt sentence and associated objective information ready for processing by the terminal.

### Step 12:

The terminal encodes the prompt sentence and determines relevant regulation segments. The terminal receives as input the prompt sentence and objective information from Step 11 and tokenizes the prompt sentence using the model's tokenizer. The terminal passes the tokenized prompt through the trained generative AI model's encoder to compute a query embedding. The terminal then queries the semantic index from Step 10 using this embedding and optionally filters results using the server-side index from Step 4. The output of Step 12 is a ranked list of regulation segments and associated metadata that are relevant to the prompt sentence.

### Step 13:

The terminal constructs a model input sequence that combines instruction, prompt sentence, and context. The terminal receives as input the prompt sentence and the selected regulation segments from Step 12 and performs text concatenation and formatting to assemble a composite sequence including a system instruction, the user's prompt, and excerpts of relevant regulation text. The terminal tokenizes this composite sequence and ensures that it conforms to the maximum input length of the generative AI model by truncating or selecting the most relevant portions. The output of Step 13 is a tokenized composite input suitable for conditioned generation.

### Step 14:

The terminal generates a regulation proposal or explanatory response by running the generative AI model. The terminal receives as input the tokenized composite sequence from Step 13 and performs a forward pass through the generative AI model to compute next-token probability distributions. The terminal applies a decoding algorithm such as beam search or nucleus sampling to select output tokens step by step, guided by probability values and constraints. The output of Step 14 is a generated token sequence representing a draft regulation proposal or explanation in natural language.

### Step 15:

The server or the terminal evaluates the generated regulation proposal against existing regulation information and harmonizes inconsistencies. The server or the terminal receives as input the generated proposal from Step 14 and relevant regulation segments from earlier steps. The server or the terminal parses the proposal text using natural language processing to extract entities, obligations, and conditions, then compares these features with corresponding features in existing regulations using both textual matching and vector similarity. The server or the terminal identifies inconsistent elements where conflicts occur in definitions, thresholds, or scopes and modifies or removes these parts according to predefined rules. The output of Step 15 is a harmonized regulation proposal that is more consistent with existing regulation information.

### Step 16:

The terminal generates and presents a response sentence to the user. The terminal receives as input the harmonized regulation proposal from Step 15 and formats the text for display by adding paragraph breaks, headings, and references to specific regulations and articles. The terminal may insert explanatory notes or highlight detected changes made during harmonization. The terminal sends the formatted text to the display subsystem. The output of Step 16 is a visible response sentence or document on the user's screen.

### Step 17:

The user provides evaluation information based on the presented response. The user observes the displayed proposal or explanation from Step 16 and inputs feedback, such as selecting that the answer is satisfactory, flagging inaccuracies, or editing specific sentences. The user's feedback is captured as evaluation information including labels, comments, or corrected text. The output of Step 17 is structured evaluation information associated with the original prompt and the generated proposal.

### Step 18:

The terminal updates training data and retrains the generative AI model using evaluation information. The terminal receives as input the evaluation information from Step 17 and the previously stored training dataset and model parameters. The terminal augments the dataset with new examples derived from corrected answers or feedback labels and computes additional gradient updates on the model parameters using a modified loss function that incorporates the evaluation signals. The output of Step 18 is an updated generative AI model and, optionally, updated vector embeddings and semantic index entries that reflect user feedback and improve future responses.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented legal information systems are primarily designed as static search engines that retrieve documents from legal databases based on keywords or simple metadata filters. Such systems require a user to have prior knowledge of applicable jurisdictions, legal terminology, and document structures, and therefore impose a heavy cognitive and operational burden on the user. In addition, traditional systems treat location information, user goals, and conversational context as separate inputs, if they are considered at all, and do not integrate these heterogeneous inputs into a unified, machine-usable representation for automated reasoning.

From a computer-technology standpoint, existing architectures do not provide a structured mechanism for dynamically binding real-time location signals, jurisdiction-specific structured legal data, and generative AI model behavior through precisely constructed prompt sentences. Back-end processors typically lack an integrated pipeline that (i) normalizes worldwide legal information into structured data per jurisdiction, (ii) associates that data with device-level location inputs, and (iii) programmatically generates optimized prompt sentences that constrain and guide a generative AI model. As a result, back-end computation is inefficient, context retrieval is ad hoc, and model inference often produces legally irrelevant or inconsistent outputs.

Furthermore, conventional systems do not perform systematic post-processing at the processor level to compare generated draft legislation or generated answer texts with existing legal data structures for consistency checking and conflict resolution. Model outputs are usually treated as final, without automated detection of conflicts, duplications, or gaps relative to a pre-existing legal corpus maintained by the server. This leads to a technical limitation in the reliability and determinism of the generative pipeline and increases the need for manual review.

Additionally, current systems do not leverage user feedback and correction requests in a structured way to update both the legal data structures and the behavior of the generative AI model. Feedback, if captured, is often stored as unstructured logs that are not systematically reintegrated into the processing pipeline, preventing continuous improvement of the server's responses and the underlying models.

Therefore, there is a need for an improved computer-implemented system and server architecture that (1) acquires and structures worldwide legal information per jurisdiction, (2) programmatically binds the structured data with user location and intent, (3) generates and manages prompt sentences to control a generative AI model, (4) automatically checks generated outputs against a structured legal corpus to detect and resolve inconsistencies, and (5) incorporates user feedback as machine-usable learning information. Such improvements should enhance the efficiency, reliability, and contextual accuracy of server-side legal information processing and generative model inference, thus constituting a concrete improvement in the functioning of computer systems that provide legal information and draft legislation support.

The specific processing by the specific processing unit 290 of the data processing device 12 in Application Example 1 is realized by the following means.

The present invention provides a server comprising a processor configured to acquire worldwide legal information from an external information source, to analyze the acquired legal information, and to convert the acquired legal information into learning information; to classify and summarize the learning information and to store the learning information as structured data representing regulatory matters for each jurisdiction; to acquire current location information of a user from a location acquisition device and to identify, based on the current location information, an applicable jurisdiction; to retrieve legal information corresponding to the applicable jurisdiction from the structured data, to convert the retrieved legal information into plain expressions by using a natural language processing technique, and to generate display information that is presentable on a user terminal; to generate a prompt sentence for causing a generative AI model to generate a draft legislation or an explanatory text, the prompt sentence being generated based on goal information input by a legislator or the user and the legal information corresponding to the applicable jurisdiction; to operate the generative AI model by using the prompt sentence and the legal information as inputs and to acquire a generated draft legislation or a generated answer text from the generative AI model; to compare the generated draft legislation or the generated answer text with existing legal information stored as the structured data, to detect inconsistency or duplication with the existing legal information, and to automatically generate correction information for resolving the inconsistency or duplication; and to generate final display information for presentation on the user terminal by using the generated draft legislation or the generated answer text and the correction information. This enables the server to technically improve computer processing of legal information by integrating jurisdiction-resolved structured data, real-time location inputs, and generative AI model control into a unified pipeline that automatically constructs optimized prompt sentences, constrains model inference with relevant legal context, performs consistency checking against a persistent legal corpus, and iteratively refines both data structures and model behavior based on user feedback, thereby enhancing the accuracy, reliability, and efficiency of machine-executed legal information retrieval and legislation drafting.
The term “processor” refers to one or more hardware computation elements, such as a central processing unit or a graphics processing unit, configured to execute instructions to perform the functions described in the present specification.
The term “legal information” refers to data representing normative rules, including at least statutes, regulations, ordinances, and related provisions issued by public authorities, in any textual or structured format.
The term “external information source” refers to any information system, storage medium, or communication service, such as a remote server, database, or network service, from which legal information can be electronically acquired.
The term “learning information” refers to processed legal information that has been analyzed, normalized, or transformed into a form suitable for machine processing, such as training, inference, classification, or summarization.
The term “structured data” refers to data organized according to a defined schema, such as tables, records, or key-value pairs, that represent legal information and associated attributes in a machine-readable form.
The term “regulatory matters” refers to topics or categories of legal obligations, prohibitions, permissions, or procedures that are defined by legal information for a particular jurisdiction.
The term “jurisdiction” refers to a geographic or governmental domain, such as a country, state, region, or municipality, in which a particular set of legal information is applicable.
The term “location acquisition device” refers to any hardware or software component configured to obtain geographic position information of a user or device, such as a positioning sensor, a satellite-based receiver, or a network-based location service.
The term “current location information” refers to data representing a present geographic position of a user or device, expressed at least by coordinates, identifiers, or region descriptors.
The term “applicable jurisdiction” refers to a jurisdiction that is determined to be relevant to the current location information of a user or device for the purpose of selecting legal information.
The term “natural language processing technique” refers to a computational method or algorithm for analyzing, transforming, or generating human language text, including at least tokenization, parsing, classification, and summarization.
The term “plain expressions” refers to text generated from legal information that is simplified or reformulated to be more easily understandable by a non-expert user, while preserving the essential legal meaning.
The term “display information” refers to data formatted for visual, auditory, or tactile output on a user terminal, including at least text, symbols, and layout-related metadata.
The term “user terminal” refers to an information processing device operated by a user, such as a mobile device, a wearable device, a personal computer, or a similar client device capable of communication with a server.
The term “goal information” refers to information describing an objective, intent, or desired outcome provided by a user or legislator, such as a policy target or a requirement for a new or revised legal rule.
The term “prompt sentence” refers to a structured natural-language or machine-readable input sequence provided to a generative AI model, including at least instructions, context, and a user query, to control or guide the model's output.
The term “generative AI model” refers to a machine learning model, implemented for example as a neural network, configured to generate text or other content based on input data including a prompt sentence.
The term “draft legislation” refers to a proposed textual legal provision or set of provisions generated by the system, intended as a candidate for enactment, amendment, or review.
The term “explanatory text” refers to generated text that explains, interprets, or summarizes legal information, draft legislation, or related concepts for a user.
The term “answer text” refers to generated text that responds to a question or request from a user based on legal information and context provided to the generative AI model.
The term “existing legal information” refers to legal information that has been previously stored as structured data and is used as a reference corpus for comparison with generated content.
The term “inconsistency” refers to a logical or normative conflict between generated content and existing legal information, including at least contradictory rules, incompatible definitions, or mutually exclusive conditions.
The term “duplication” refers to unnecessary repetition or substantial overlap between generated content and existing legal information, such that two or more provisions substantially cover the same regulatory matter.
The term “correction information” refers to data indicating one or more modifications, deletions, additions, or annotations that are intended to resolve an inconsistency or duplication between generated content and existing legal information.
The term “final display information” refers to display information that has been generated after application of correction information to generated content and that is intended for presentation to the user on a user terminal.
The term “question sentence” refers to a natural-language or structured input provided by a user that requests information, clarification, or advice related to legal information.
The term “context information” refers to data that supplements a prompt sentence, including at least legal information, location information, user attributes, or prior interaction history, to guide the behavior of a generative AI model.
The term “location-dependent legal information” refers to legal information that is selected or filtered based on current location information or an applicable jurisdiction associated with a user or device.
The term “interactive format” refers to a mode of presenting and updating information in which a user can iteratively input questions, receive answers, and provide additional inputs in a dialog-like sequence.
The term “evaluation information” refers to information provided by a user that reflects an assessment of the quality, relevance, correctness, or usefulness of generated content.
The term “correction request information” refers to information provided by a user that indicates desired changes, clarifications, or corrections to generated content.
The term “revised draft legislation” refers to draft legislation that has been modified by the system based on evaluation information, correction request information, or detected inconsistencies or duplications.
The term “revised answer text” refers to an answer text that has been updated by the system using evaluation information, correction request information, or additional legal information.
The term “updating the structured data” refers to modifying stored structured data by adding, changing, or deleting entries based on newly generated or revised content.
The term “updating the generative AI model” refers to adjusting parameters, training data, configuration, or prompt-generation strategies associated with a generative AI model to modify its subsequent behavior based on new learning information.

In one embodiment, a server implements the claimed system as a network-connected computing device including at least one central processing unit, at least one memory device, at least one non-volatile storage device, and at least one network interface. The server executes an operating system, such as a general-purpose server operating system, and middleware such as a web application framework. The server further executes application modules that perform legal information acquisition, text analysis, structured data management, prompt sentence generation, generative AI model interaction, consistency checking, and response generation.

The server acquires worldwide legal information from external information sources over a communication network. The server uses a communication module that issues hypertext transfer protocol secure requests via a network interface. The server receives responses in formats such as structured markup, semi-structured text, or serialized data. The server stores the raw responses temporarily in a persistent storage device as files. The server parses each response using a parsing module that employs text parsing libraries. The server extracts attributes such as jurisdiction identifiers, document identifiers, article identifiers, section titles, body text, enactment dates, and amendment dates, and converts them into normalized records.

The server converts the normalized records into learning information suitable for downstream machine processing. The server uses a text analysis module that runs on the processor and applies natural language processing techniques. The server tokenizes legal texts into tokens, segments them into sentences, and applies part-of-speech tagging and syntactic dependency parsing. The server detects named entities such as geographical names, institutional names, monetary values, and temporal expressions. The server computes additional features including term frequency-inverse document frequency scores, topic labels, and rule-type labels (for example, obligation, prohibition, permission). The server stores the resulting features in a relational schema comprising jurisdiction tables, statute tables, article tables, and feature tables, thereby forming structured data.

The server classifies and summarizes the learning information to create structured data representing regulatory matters for each jurisdiction. The server associates each legal provision with one or more regulatory matter identifiers, such as public conduct, commercial transactions, taxation, immigration, or transportation. The server performs this association by executing a categorization algorithm implemented as a supervised classifier, for instance a gradient-boosted decision tree or a neural classifier, trained on feature vectors derived from the text analysis. The server also computes extractive and abstractive summaries using a sequence-to-sequence neural network. The server stores these summaries alongside original texts, thus enabling efficient retrieval of condensed legal content.

The server generates semantic vector representations of legal provisions for use in fast similarity search. The server invokes a neural embedding model implemented as a transformer-based encoder. The server maps each tokenized article to a fixed-length numerical vector by applying multiple self-attention layers and pooling mechanisms. The server stores the resulting vectors in a vector index, such as a table extended with a vector-type column or a dedicated approximate nearest neighbor index. The server thereby enables high-speed similarity searches across worldwide legal information by using vector distance metrics.

The server acquires current location information of a user from a location acquisition device via a communication interface. The terminal operates as the location acquisition device. The terminal includes a positioning sensor, such as a global navigation satellite system receiver, and operating system level location services. The terminal obtains current latitude and longitude coordinates and optionally an accuracy parameter. The terminal transmits the current location information to the server over a secure communication channel. The server receives the coordinates and maps them to an applicable jurisdiction using a geospatial mapping module that references a geospatial database. The server selects a country, and optionally a lower-level region such as a state, province, or municipality, as the applicable jurisdiction.

The server retrieves legal information corresponding to the applicable jurisdiction from the structured data. The server executes structured queries against the relational schema, filtering by jurisdiction identifiers and regulatory matter types. The server optionally refines the selection by applying a vector similarity search using the semantic vectors in the vector index, thereby selecting the most relevant articles for the current context. The server converts the retrieved legal information into plain expressions by applying a natural language processing technique that includes simplification and paraphrasing. The server uses a text simplification model, which may be a transformer-based encoder-decoder neural network trained to map complex legal sentences to simplified sentences while preserving logical structure. The server outputs display information comprising plain-text explanations, article references, and grouping by regulatory matter. The server serializes the display information and transmits it to the terminal.

The terminal presents the display information to the user. The terminal executes a user interface application that receives the display information via a network stack. The terminal renders the display information on a display device such as a touch-sensitive screen or a head-mounted display. The terminal uses platform-specific user interface components to arrange the information into sections, headings, and lists. The terminal may store a subset of the display information in a local storage component to support offline viewing and to decrease repeated communication with the server, thereby reducing communication load.

The user views the displayed legal information and provides goal information or question sentences. In one use case, the user acts as a legislator and inputs goal information describing a policy objective, such as reducing noise in urban areas or clarifying rules on data protection. In another use case, the user acts as a traveler or citizen and inputs a question sentence about applicable rules in the current jurisdiction, such as whether drinking alcoholic beverages is allowed in a public park. The terminal captures the input through a text input component or a voice recognition component. The terminal may perform preliminary processing such as language detection and spelling normalization.

The server generates a prompt sentence for controlling a generative AI model. The server receives the goal information or question sentence, together with the applicable jurisdiction and selected legal provisions. The server constructs a prompt sentence by concatenating system instructions, contextual legal excerpts, and the user-provided content according to a predefined template. The server specifies in the prompt sentence constraints such as the applicable jurisdiction, the requirement to cite article identifiers, and the need to explain exceptions and penalties. In one example, when the user is located in a city within a European country and inputs a question about drinking alcohol in public spaces, the server constructs a prompt sentence such as:
“System: You are a legal assistant. Use only the legal texts provided below for the user's current jurisdiction.
Context: Jurisdiction =[Country], City =[City]. Topic =public alcohol consumption.
Legal excerpts: [insert selected articles and summaries here].
User question: Can I drink beer in a public park in this city? Please explain any restrictions, such as time limits, container requirements, and possible penalties, and refer to relevant articles.”

In another example, when the user asks about carrying medication through airport security in a region, the server constructs a prompt sentence such as:
“System: You are a legal and regulatory information assistant specialized in travel and security rules. Use only the legal and official guidance texts provided below.
Context: Jurisdiction =[Country], Airport region =[Region]. Topic =airport security and medication.
Legal excerpts: [insert relevant statutory guidance and regulations].
User question: What are the rules for carrying over-the-counter medication through airport security in this region? Explain allowed quantities, packaging, and documentation, if any.”

The server uses this prompt sentence to guide the behavior of a generative AI model.

The server operates the generative AI model by supplying the prompt sentence and the relevant legal information as inputs. In one embodiment, the generative AI model is a transformer-based neural network comprising multiple layers of multi-head self-attention, feed-forward sub-layers, and positional encodings. The server encodes the prompt sentence and legal excerpts into token sequences, converts the tokens to embeddings using learned embedding matrices, and applies the transformer layers to compute contextualized representations. The server generates output tokens using an auto-regressive decoding procedure, where each output token is produced based on previously generated tokens and the encoded context. The server sets model parameters such as maximum output length, temperature, and sampling strategy to control determinism and verbosity. The server receives the generated sequence as a draft legislation or an answer text.

The server compares the generated draft legislation or answer text with existing legal information stored as structured data. The server first aligns generated text segments with structured articles using similarity measures. The server uses both lexical similarity (for example, cosine similarity over term frequency-inverse document frequency vectors) and semantic similarity (for example, cosine similarity over precomputed embeddings) to identify candidate matches. The server then applies rule-based consistency checks. For example, the server checks whether a generated provision that imposes a new obligation conflicts with an existing provision that explicitly permits the same conduct under identical conditions. The server also checks for duplication by determining whether a generated provision covers the same regulatory matter with substantially equivalent conditions and effects as existing provisions.

The server automatically generates correction information to resolve detected inconsistencies or duplications. The server uses a rule engine that applies predetermined legal consistency rules, such as precedence of higher-level statutes over lower-level ordinances, and constraints relating to temporal validity and territorial scope. The server may also invoke a secondary text processing model to propose redlined changes or annotations that reconcile conflicts. The server generates correction information that includes suggested deletions, insertions, or amendments. The server associates the correction information with the generated draft legislation or answer text and stores this information for subsequent presentation and for updating the structured data.

The server generates final display information by combining the generated content with the correction information. The server may visually distinguish unmodified parts from corrected parts by using markup tags or metadata. The server structures the final display information into sections such as “Proposed rule,” “Consistency notes,” and “Related existing regulations,” and transmits the final display information to the terminal. The terminal displays the final information so that the user can review both the generated content and the system-detected consistency notes.

The server incorporates user feedback and correction requests into the processing pipeline. When the user indicates that a generated answer is incomplete, unclear, or incorrect, the terminal captures evaluation information or correction request information and transmits it to the server. The server records the feedback together with associated prompt sentences, jurisdiction data, and selected legal excerpts. The server uses the feedback to create new training examples for the generative AI model and auxiliary models. For example, the server may construct pairs of original answers and corrected answers and use them to fine-tune the transformer parameters with a supervised loss function, such as cross-entropy between predicted token distributions and corrected token sequences. The server may also adjust prompt generation templates based on patterns in feedback, optimizing the structure and content of future prompt sentences.

The server provides technical improvements beyond mere automation of manual tasks. By maintaining jurisdiction-specific structured data and semantic indices, the server reduces the search space for relevant legal provisions, which improves calculation efficiency and reduces memory bandwidth usage. The server's prompt sentence generation algorithm programmatically encodes jurisdiction, regulatory matter classification, and user intent into a compact textual representation. This structured prompt design allows the generative AI model to focus its computation on a restricted context, reducing unnecessary processing of irrelevant tokens and thus improving throughput and latency.

The server's consistency checking module provides an additional layer of automated validation that is not performed in conventional systems. By combining vector-based similarity, rule-based logic, and hierarchical legal precedence rules, the server can algorithmically detect conflicting or redundant provisions. This reduces the need for exhaustive manual cross-checking and enhances the reliability of generated legislation or answers, thereby improving the technical quality of the overall system output.

The server improves data management by maintaining synchronized relationships among raw legal texts, extracted features, semantic vectors, generated content, and feedback data. The server stores these data in coordinated schemas and indices, enabling efficient cross-referencing and incremental updating. When a legal provision changes, the server can recompute associated features, embedding vectors, and summaries, and can selectively retrain or fine-tune model components, thereby maintaining model accuracy and reducing drift.

The terminal contributes to technical effects by leveraging location information, caching, and adaptive user interface rendering. The terminal's acquisition of precise current location information reduces the volume of legal information that must be transmitted from the server, because the server can restrict responses to an applicable jurisdiction. This reduces communication traffic and lowers response times. The terminal may cache frequently accessed legal summaries per jurisdiction, allowing the server to omit re-sending unchanged content. The terminal thereby participates in communication load reduction and response latency improvement.

The generative AI model and associated algorithms operate under detailed, non-conventional rules defined by prompt sentences and consistency constraints. Unlike a human expert, who might informally read and interpret legal texts, the server enforces explicit algorithmic steps: vectorization of texts, nearest-neighbor retrieval in an embedding space, template-based prompt construction, transformer-based generation, and structured conflict detection. These steps, when executed by a processor, provide deterministic and repeatable behavior that can be tuned by adjusting model parameters, thresholds, and indexing configurations. The combination of these elements constitutes an improvement in the functioning of computer systems that process legal information, rather than merely reproducing mental steps.

Alternative embodiments may vary the underlying hardware and software components. The server may use different types of processors, including many-core processors or specialized accelerators, to perform neural network inference and training. The server may implement different neural architectures, such as recurrent neural networks or convolutional sequence models, instead of or in addition to transformer architectures. The server may employ different storage backends, such as distributed key-value stores or document databases, in place of or alongside relational databases. The terminal may be implemented as a smartphone, a tablet, a wearable device, or an in-vehicle information system. The location acquisition may rely on satellite positioning, cellular network triangulation, wireless access point fingerprints, or a combination thereof.

In all embodiments, the server, terminal, and user interact in such a manner that the server performs concrete technical operations on structured data, neural representations, and prompt sentences to deliver jurisdiction-aware, consistency-checked legal information and draft legislation. The system thereby provides specific improvements in processing speed, accuracy, data management, and communication efficiency, and constitutes a technical solution to the problem of how to efficiently and reliably generate and present legal information and draft legal texts using a generative AI model controlled by programmatically generated prompt sentences.

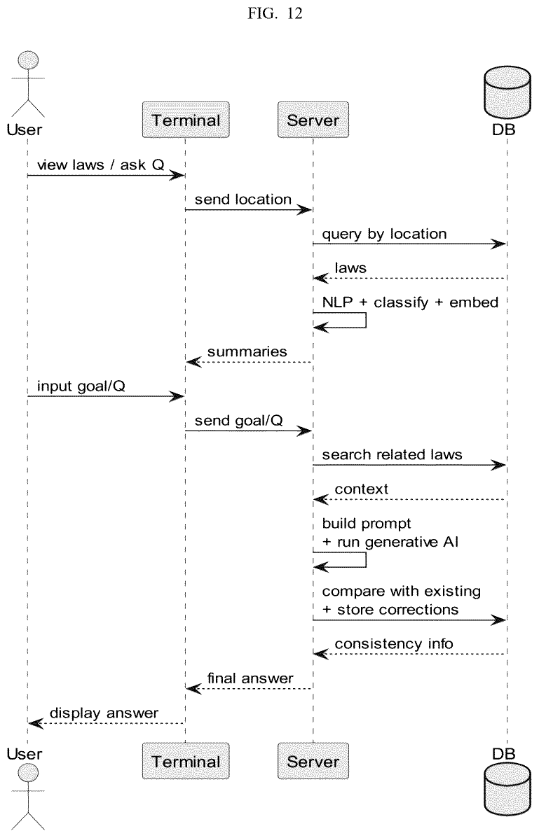

The following describes the processing flow using FIG. 12.

### Step 1:

Server acquires worldwide legal information from external information sources.

Server receives, as input, connection parameters and endpoint identifiers for external data providers, and sends secure network requests using a communication library. Server obtains, as output, raw legal documents in formats such as structured markup, semi-structured text, or serialized data. Server performs data acquisition by opening a network socket, transmitting request headers and parameters, receiving response payloads, and writing the payloads as files or streams into non-volatile storage.

### Step 2:

Server parses the acquired legal documents and normalizes them into internal records.

Server takes, as input, the raw legal document files produced in Step 1. Server applies parsing routines that tokenize markup, identify tag structures, and extract fields such as jurisdiction indicators, document identifiers, article identifiers, headings, body text, and temporal attributes. Server performs data processing by mapping heterogeneous field names into a canonical schema and converting character encodings to a unified format. Server outputs normalized legal records stored in memory as structured objects.

### Step 3:

Server converts normalized legal records into structured database entries.

Server takes, as input, the normalized legal records created in Step 2. Server performs data insertion operations into a relational schema, using database access libraries to execute insert statements or batch uploads. Server computes foreign-key relationships among jurisdiction tables, statute tables, and article tables. Server outputs persistent structured data rows in database tables, thereby creating a machine-readable legal corpus.

### Step 4:

Server performs natural language processing on legal text to derive features and annotations.

Server receives, as input, article texts retrieved from the database together with jurisdiction and document identifiers. Server executes tokenization, sentence segmentation, part-of-speech tagging, and dependency parsing using a text analysis library. Server also performs named entity recognition, extracting entities such as geographic names, institutional names, and temporal expressions. Server computes feature vectors that include token indices, syntactic dependencies, and statistical measures. Server outputs enriched legal records containing both original text and derived features, and writes them back into feature tables or associated columns in the database.

### Step 5:

Server classifies legal provisions into regulatory matters and generates summaries.

Server takes, as input, the feature-enriched legal records from Step 4. Server feeds the feature vectors into a trained classification model to assign each record to one or more regulatory matter categories, such as public conduct, transportation, or commercial activities. Server then applies a sequence-to-sequence summarization model to produce concise textual summaries of each provision. Server performs data processing by running inference on the models, computing category probabilities and generating summary tokens. Server outputs updated legal records with category labels and summary texts, and stores these in the structured database.

### Step 6:

Server computes semantic vector representations for efficient similarity search.

Server receives, as input, tokenized article texts and summary texts from Step 5. Server passes these sequences through an embedding model that encodes each sequence into a fixed-length numerical vector by applying multiple layers of self-attention and pooling. Server performs linear algebra operations on the processor or accelerator, such as matrix multiplications and normalization. Server outputs embedding vectors and stores them in a vector index, associating each vector with corresponding article identifiers in a vector-enabled database or index structure.

### Step 7:

Terminal acquires current location information of the user.

Terminal takes, as input, a request from an application component to determine the user's geographic position. Terminal activates a location acquisition device such as a positioning sensor and obtains raw sensor readings. Terminal performs coordinate computation using the operating system's location services, which fuse signals from satellite, cellular, and wireless sources. Terminal outputs current location information, including latitude, longitude, and optional accuracy metrics, and holds this information in memory.

### Step 8:

Terminal transmits current location information to the server.

Terminal receives, as input, the current location information from Step 7 and communication parameters for the server. Terminal constructs a request payload containing coordinate values and device identifiers and sends it via a secure transport protocol. Terminal performs network operations, including opening a connection, encoding the payload, and handling possible communication errors. Terminal outputs a transmitted location message that arrives at the server as an incoming request.

### Step 9:

Server determines an applicable jurisdiction based on current location information.

Server receives, as input, the transmitted location message containing latitude and longitude. Server executes a geospatial mapping routine using a geospatial database or mapping table that links coordinate ranges to jurisdiction identifiers. Server performs coordinate comparison, region lookup, and, if necessary, hierarchical resolution from country level down to local government units. Server outputs an applicable jurisdiction identifier, which specifies at least a country and optionally a sub-region, and stores this identifier for subsequent use.

### Step 10:

Server retrieves jurisdiction-specific legal information from structured data.

Server takes, as input, the applicable jurisdiction identifier from Step 9. Server executes database queries that select legal records whose jurisdiction field matches the identifier and whose regulatory matter categories are relevant to preconfigured topics or user preferences. Server may additionally apply a similarity filter using the embedding vectors to prioritize provisions most relevant to typical location-based queries. Server outputs a collection of jurisdiction-specific legal records that include full texts, summaries, and category labels.

### Step 11:

Server generates plain-language display information from jurisdiction-specific legal records.

Server receives, as input, the jurisdiction-specific legal records obtained in Step 10. Server invokes a text simplification model that takes legal sentences as input and outputs simplified sentences. Server performs neural inference operations that map complex token sequences to simpler sequences while preserving logical relations, using forward passes through encoder-decoder layers. Server groups simplified texts according to regulatory matters and attaches references to original article identifiers. Server outputs structured display information composed of plain-language explanations, headings, and article references prepared for transmission to the terminal.

Step 12:

Server transmits display information to the terminal.

Server takes, as input, the structured display information produced in Step 11 and connection information related to the requesting terminal. Server formats the display information into a response payload and sends it via a secure communication protocol. Server performs data serialization, header generation, and network transmission through the network interface. Server outputs a response message that carries the display information to the terminal.

### Step 13:

Terminal presents jurisdiction-specific legal information to the user.

Terminal receives, as input, the response message from Step 12. Terminal parses the message and extracts the structured display information. Terminal performs user interface operations by mapping sections and explanations to visual components such as lists, cards, or text blocks. Terminal renders the information on a display device and may store a subset of the display information in local storage for later reuse. Terminal outputs a user-visible screen presenting jurisdiction-specific legal summaries.

### Step 14:

User supplies goal information or a question sentence via the terminal interface.

User views the displayed legal information provided in Step 13 and decides to obtain additional information or propose a legislative objective. User provides, as input, either goal information describing a desired legal outcome or a question sentence about specific conduct or rules. User interacts with an input device, such as a keyboard, touch screen, or microphone, to enter the content. User outputs natural-language text that the terminal receives as user input data.

### Step 15:

Terminal captures and pre-processes user input.

Terminal receives, as input, the natural-language text produced by the user in Step 14. Terminal may perform optional pre-processing such as language detection, normalization of whitespace, and correction of simple typographical errors. Terminal encodes the processed text as a structured representation including text content, input language, and timestamp. Terminal outputs a cleaned user input object representing either goal information or a question sentence.

### Step 16:

Server receives user input and identifies relevant legal context.

Server takes, as input, the cleaned user input object from Step 15 and the applicable jurisdiction identifier from Step 9. Server executes search routines against the structured data to identify legal records related to the user input. For a question sentence, server computes an embedding vector of the question and performs nearest-neighbor search in the embedding space. For goal information, server compares key terms with regulatory matter categories and existing provisions. Server outputs a set of context legal records and associated excerpts that are most relevant to the user input.

### Step 17:

Server constructs a prompt sentence for a generative AI model.

Server receives, as input, the user input data and the context legal records from Step 16. Server applies a template-based construction algorithm that arranges system instructions, jurisdiction information, selected legal excerpts, and the user's text into a single prompt sentence. Server performs string concatenation, insertion of placeholders, and, if necessary, truncation of less relevant excerpts to stay within a token limit. Server outputs a fully assembled prompt sentence that encodes model instructions, context, and the user's request.

### Step 18:

Server invokes the generative AI model with the prompt sentence and context.

Server takes, as input, the prompt sentence from Step 17 and, optionally, additional context metadata such as maximum output length and response style. Server tokenizes the prompt sentence, maps tokens to numerical embeddings, and passes them into a transformer-based neural network. Server computes layer-wise activations through multiple self-attention and feed-forward layers, then decodes output tokens in an auto-regressive manner using a chosen sampling strategy. Server outputs a generated text sequence interpreted as a draft legislation or an answer text.

### Step 19:

Server compares generated text with existing legal information for consistency and duplication.

Server receives, as input, the generated text sequence from Step 18 and the corpus of existing structured legal records for the applicable jurisdiction. Server segments the generated text into clauses or provisions and computes feature representations, including lexical and semantic similarity vectors. Server performs pairwise comparisons between generated clauses and existing articles using similarity thresholds and predefined legal consistency rules. Server detects instances where a generated clause contradicts an existing clause or reproduces substantially the same rule. Server outputs a list of detected inconsistencies and duplications, each associated with references to both generated and existing provisions.

### Step 20:

Server generates correction information to resolve inconsistencies and duplications.

Server takes, as input, the list of inconsistencies and duplications from Step 19. Server applies a rule engine that encodes precedence relationships among different levels of legal authority and defines strategies for resolving conflicts, such as narrowing scope, clarifying exceptions, or removing redundant clauses. Server may generate suggested modifications as redlined text or annotated comments. Server outputs correction information describing specific changes (for example, deletions, insertions, or rephrasings) to be applied to the generated text.

### Step 21:

Server composes final display information combining generated content and correction information.

Server receives, as input, the original generated text from Step 18 and the correction information from Step 20. Server applies the corrections to the generated text by inserting, deleting, or altering segments according to the suggested modifications. Server constructs a final representation that includes both the corrected text and explanatory notes about the changes and underlying existing laws. Server outputs final display information structured into sections such as proposed rules, conflict notes, and references.

### Step 22:

Server transmits final display information to the terminal.

Server takes, as input, the final display information produced in Step 21 and terminal connection information. Server serializes the final display information into a response payload and sends it to the terminal using a secure communication protocol. Server performs necessary encoding, header creation, and network transmission. Server outputs a response message containing the final display information.

### Step 23:

Terminal displays generated draft legislation or answer text with consistency annotations.

Terminal receives, as input, the response message from Step 22. Terminal parses the payload and extracts the final display information. Terminal renders the corrected draft legislation or answer text on a display device, highlighting sections that have been modified or annotated. Terminal may provide interactive elements allowing the user to expand or collapse explanations and navigate to referenced existing provisions. Terminal outputs a user-visible representation that includes both substantive content and system-generated consistency notes.

### Step 24:

User reviews the final display information and may provide feedback or correction requests.

User views, as input, the displayed draft legislation or answer text along with annotations. User evaluates whether the information is accurate, clear, and appropriate. User may enter feedback indicating agreement, disagreement, or a need for additional clarification, or may propose specific corrections. User interacts with feedback controls or text input components to submit such evaluation information or correction request information. User outputs feedback data that the terminal can capture.

### Step 25:

Terminal captures user feedback and sends it to the server.

Terminal receives, as input, the evaluation information or correction request information from the user in Step 24. Terminal associates the feedback with identifiers for the corresponding prompt sentence, generated content, and jurisdiction. Terminal constructs a feedback payload containing these elements and transmits it to the server using a secure communication protocol. Terminal outputs a feedback message that reaches the server as an incoming request.

### Step 26:

Server incorporates feedback into learning information and adjusts models or prompt strategies.

Server takes, as input, the feedback message from Step 25 and the historical prompt sentences and generated contents stored in logs or databases. Server creates training pairs or adjustment rules by linking original outputs to corrected or desired outputs indicated by the user. Server updates model parameters through additional training passes, using a loss function such as token-level cross-entropy to reduce divergence between model predictions and feedback-based targets. Server also modifies prompt construction templates by adjusting which context fields are emphasized or how instructions are phrased. Server outputs updated learning information, including revised structured data entries and adjusted model states, thereby improving subsequent processing accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for generating legislative or normative drafts based on user input typically forward a user's natural language request directly to a generative AI model, or apply only shallow pre-processing such as keyword extraction. Such architectures treat the generative AI model as a black box and do not provide an integrated, machine-controlled pipeline that (i) structurally analyzes a user's goal, (ii) systematically constrains the model based on existing normative information, (iii) retrieves and leverages similar prior information in a reproducible manner, and (iv) iteratively refines outputs based on user feedback while preserving internal machine-readable representations. As a result, these systems often produce draft texts that are inconsistent with existing normative frameworks, are difficult to reproduce or audit, and require extensive human intervention and domain expertise to correct.

From a computer technology standpoint, existing systems do not effectively utilize the processor and memory hierarchy to maintain an internal structured representation of a user's goal, to generate vector embeddings for similarity search, to manage constraint information derived from past normative information, and to automatically construct prompt sentences that tightly control the behavior of a generative AI model. The lack of such coordinated processing steps leads to inefficient use of computing resources, redundant interactions with external AI services, and unstable output quality. Furthermore, feedback from users is usually handled in an ad hoc, text-only manner, without updating structured goal data and constraint data inside the system, which prevents the system from improving its internal state and from achieving stable, machine-optimized refinement cycles.

Accordingly, there is a need for a computer-implemented system that improves the functioning of the processor and associated memory by: (1) transforming unstructured natural language input into structured goal information using natural language processing; (2) generating numerical feature vectors and performing similarity searches against stored normative and proposal information; (3) deriving and maintaining constraint information representing consistency conditions and contradiction candidates with respect to existing normative information; (4) automatically generating prompt sentences for a generative AI model based on the structured goal information and the constraint information; and (5) iteratively updating the structured data and constraint data in response to user feedback. Such a system would provide more consistent, controllable, and resource-efficient generation of draft normative texts, and would improve the overall computer technology used to manage complex, constraint-rich text generation tasks.

The specific processing by the specific processing unit 290 of the data processing device 12 in Example 2 is realized by the following means.

The present invention provides a server comprising a processor configured to obtain goal information expressed in natural language from a user terminal and to store the goal information as text data in a memory; to execute a natural language processing program to perform linguistic analysis on the text data and to generate structured goal data representing a structure and key concepts of the goal; to execute an embedding generation program to convert at least one of the structured goal data and the text data into a numerical feature vector; to access a storage device that stores normative information and proposal information, and to perform a similarity search based on the feature vector to retrieve past normative information or past proposal information; to compare the structured goal data with the retrieved information and to derive constraint data including consistency conditions and contradiction candidates with respect to existing normative information; to automatically construct a machine-readable prompt sentence for a generative AI model based on the structured goal data and the constraint data, the prompt sentence including explicit instructions, conditions, and output format; to transmit the prompt sentence to the generative AI model via a communication interface and to receive draft text data corresponding to the goal; to execute a verification process using the constraint data and the normative information stored in the storage device to detect and correct contradictions in the draft text data and to generate revised draft text data; and to provide display data based on the revised draft text data to the user terminal for presentation to the user, and further to update at least one of the structured goal data and the constraint data based on feedback information received from the user terminal and to regenerate the prompt sentence for subsequent interactions with the generative AI model. This enables the computer system to internally control and constrain the behavior of the generative AI model through structured representations and constraint management, thereby improving consistency with existing normative information, reducing the need for manual correction, enhancing reproducibility and auditability of generated drafts, and achieving more efficient use of processing and storage resources in the generation and refinement of complex normative text.
The term “goal” refers to information representing an intended legislative, regulatory, or normative objective expressed by a user in natural language, including desired outcomes, conditions, and constraints to be realized by a draft text.
The term “terminal” refers to an information processing apparatus operated by a user, such as a client device with a display and input interface, that transmits goal information and feedback information to a server and receives display data from the server.
The term “server” refers to an information processing apparatus, including at least one processor and at least one memory, that performs analysis, storage, similarity search, prompt construction, model interaction, verification, and output generation based on data received from a terminal.
The term “text data” refers to data representing a sequence of characters or tokens that encode a user's goal or a draft text, in a machine-readable format suitable for processing by natural language processing programs.
The term “natural language processing program” refers to software that analyzes text data in a human language to obtain linguistic information such as tokens, parts of speech, syntactic structure, named entities, and key phrases.
The term “structured goal data” refers to data generated by the natural language processing program that represents a goal in a machine-readable structured format, including at least one of fields, attributes, or relationships indicating a structure and key concepts of the goal.
The term “embedding generation program” refers to software that converts text data or structured goal data into a numerical feature vector in a multidimensional space for use in similarity search or other computational analysis.
The term “feature vector” refers to a numerical representation of at least part of the goal or related information, typically comprising a plurality of real-number components, that enables similarity computation between different items.
The term “storage device” refers to a non-transitory computer-readable medium, such as a database or data store, that stores normative information, proposal information, feature vectors, constraint data, and other data used by the server.
The term “normative information” refers to information describing rules, obligations, permissions, or prohibitions, including laws, regulations, policies, guidelines, or similar normative texts stored in the storage device.
The term “proposal information” refers to information describing previously generated or stored draft texts, model outputs, or suggested normative measures related to one or more goals.
The term “similarity search” refers to a computational process in which a feature vector corresponding to a query is compared with feature vectors stored in the storage device to identify and retrieve items with similarity above a threshold according to a similarity metric.
The term “constraint data” refers to machine-readable data derived from structured goal data and retrieved information that represents conditions, requirements, and contradiction candidates used to constrain or verify generated draft text.
The term “consistency condition” refers to a rule or requirement included in the constraint data that specifies how a generated draft text should be aligned with existing normative information or with the goal.
The term “contradiction candidate” refers to an element or relationship identified during comparison that may conflict with existing normative information or specified conditions and that is stored as part of the constraint data.
The term “prompt sentence” refers to a machine-readable instruction string or set of strings generated by the server and provided as input to a generative AI model, the instruction string including at least a representation of the goal, conditions, and an output format.
The term “generative AI model” refers to a trained information generation model, such as a neural network-based text generation model, that receives a prompt sentence as input and outputs draft text data corresponding to the prompt sentence.
The term “draft text data” refers to text data produced by the generative AI model in response to a prompt sentence, the text data representing at least a draft of a legislative, regulatory, or normative document.
The term “verification process” refers to processing by the server in which the draft text data is evaluated using constraint data and normative information to detect, highlight, or correct contradictions or violations of specified conditions.
The term “revised draft text data” refers to draft text data that has been modified by the server through the verification process to remove or adjust contradictions with existing normative information or specified constraints.
The term “display data” refers to data derived from draft text data or revised draft text data that is formatted for presentation on a terminal, including at least one of plain text, structured text, or markup language.
The term “feedback information” refers to information provided by a user through the terminal that evaluates, approves, rejects, or requests modification of the draft text data or revised draft text data, including comments, ratings, or additional constraints.
The term “correction request information” refers to a type of feedback information that specifies changes, additions, or deletions desired by the user with respect to the content or structure of the draft text data.
The term “updated constraint data” refers to constraint data that has been modified based on feedback information or correction request information, and that is used to regenerate a prompt sentence for subsequent interaction with the generative AI model.
The term “communication interface” refers to hardware and software components that enable data exchange between the server and external systems, including at least the terminal and the generative AI model service.
The term “memory” refers to one or more non-transitory computer-readable storage media that store programs, structured goal data, feature vectors, normative information, constraint data, and other data used by the processor.

In one embodiment, a server cooperates with at least one terminal operated by a user to implement the claimed system. The server includes at least one processor, at least one main memory, a non-volatile storage device, and a communication interface connected to a communication network. The terminal includes at least one processor, a memory, a display, and an input device, and executes a web browser or a dedicated client application to communicate with the server.

The server executes an operating system such as a general-purpose server operating system and runs an application program implemented, for example, using a web framework and a scripting runtime. The server stores, in the storage device, program modules including a natural language processing module, an embedding generation module, a similarity search module, a constraint management module, a prompt generation module, a generative AI model interface module, a verification module, and a presentation module. The server further stores a normative database, a proposal database, a feature vector index, and logs of user goals, generated prompt sentences, and generated draft texts.

The terminal provides a graphical user interface for the user. The terminal displays an input field and allows the user to input a goal in natural language such as a legislative or normative objective. The terminal transmits the input goal to the server via the communication interface using an application-layer protocol. The terminal subsequently receives display data from the server and renders the data on the display using the web browser or client application.

The server stores the received goal as text data in the memory and associates the text data with a unique goal identifier. The server executes the natural language processing module implemented, for example, using a general-purpose natural language processing library such as a tokenization and parsing engine. The server loads a language model, which may be a neural sequence model or a statistical model, into the memory and applies the model to the text data. The server performs tokenization, part-of-speech tagging, dependency parsing, and named entity recognition. The server generates structured goal data that encodes the internal structure of the goal as fields such as objectives, constraints, jurisdiction, target entities, and temporal conditions.

The server executes the embedding generation module to convert at least part of the structured goal data and/or the text data into a numerical feature vector. The server uses a trained embedding model that maps an input token sequence to a fixed-length vector in a high-dimensional space. In one example, the server uses a feedforward neural network or a transformer-based encoder with multiple attention heads. The server multiplies input token embeddings by learned weight matrices, applies non-linear activation functions, aggregates contextual information using self-attention, and outputs a feature vector. The server stores the feature vector together with the goal identifier in the feature vector index.

The server executes the similarity search module to query the feature vector index. The server uses a similarity metric such as cosine similarity or inner product to compute similarity scores between the newly generated feature vector and stored feature vectors corresponding to previously stored normative information and proposal information. The server retrieves a set of candidate items with similarity scores above a threshold. The server obtains associated normative texts and proposal texts from the normative database and the proposal database using identifiers stored with the feature vectors.

The server executes the constraint management module to compare the structured goal data with the retrieved normative texts and proposal texts. The server converts the retrieved texts into internal representations, which may include parsed syntactic structures, logical predicates, or tagged sections. The server applies rule-based algorithms that identify patterns corresponding to permissions, obligations, prohibitions, and exceptions. The server identifies consistency conditions that must be satisfied by any new draft text and identifies contradiction candidates where the structured goal data appears to conflict with existing normative rules. The server stores these conditions and candidates as constraint data that references specific sections or concepts in the normative database.

The server executes the prompt generation module to construct a prompt sentence for a generative AI model. The server uses a prompt template stored in the storage device and fills the template with elements derived from the structured goal data and the constraint data. The server includes explicit instructions, conditions, and an output format in the prompt sentence. The server may generate, for a goal relating to immigration policy, a prompt sentence such as:
“You are an expert legislative drafter specializing in immigration and labor law in a specified jurisdiction.
Based on the following goal, draft a comprehensive immigration bill:
Goal: Create a bill that reduces illegal immigration while increasing the number of foreign workers in the jurisdiction.

Requirements:
1. Propose clear categories for entry and residence (for example, skilled, semi-skilled, seasonal) and eligibility criteria.
2. Include enforcement mechanisms that deter illegal immigration (for example, border controls, employer obligations, monitoring systems).
3. Encourage legal entry of foreign workers through streamlined procedures and appropriate rights protections.
4. Avoid contradictions with existing immigration and labor laws identified in the internal constraint data.
5. Provide (a) an executive summary, (b) a section-by-section explanation, and (c) draft legal provisions in article format.

Now draft the text of the bill and briefly explain the rationale for each major article.”

The server thus generates prompt sentences that are not simple restatements of user input but are derived from internal structured data and constraint data. This construction constrains the behavior of the generative AI model and reduces output variability.

The server executes the generative AI model interface module to transmit the prompt sentence to an external or internal generative AI model. In one embodiment, the generative AI model is implemented as a multi-layer neural network of the transformer type with self-attention layers, feedforward layers, and normalization layers. The generative AI model is trained on text corpora using a next-token prediction objective and an error function such as cross-entropy loss. During training, model parameters are updated using gradient descent and variants thereof. The generative AI model uses the prompt sentence as context, computes attention weights across tokens, and generates output tokens by repeatedly selecting the most probable next token under a controlled sampling scheme.

The server receives draft text data from the generative AI model. The server stores the draft text data as part of the proposal database and associates the draft text data with the goal identifier and the prompt sentence. The server executes the verification module to compare the draft text data with the constraint data and the normative database. The server segments the draft text data into sections and articles and maps these segments to internal representations. The server checks whether any segment violates a consistency condition or matches a contradiction candidate in the constraint data. The server applies correction rules, which may include deletion of contradictory clauses, insertion of clarifying language, or modification of terms to align with pre-existing definitions in the normative database. The server generates revised draft text data in which contradictions are resolved or labeled.

The server executes the presentation module to transform the revised draft text data into display data suitable for the terminal. The server may insert headings, numbering, and markup to structure the information. The server may also create summary views or highlight sections corresponding to specific constraints. The server transmits the display data to the terminal.

The user reviews the displayed draft text on the terminal and may provide feedback information, such as approval, disapproval, or requests for modification. The terminal transmits feedback information back to the server. The server updates the structured goal data and the constraint data using the feedback information. The server may extend the constraint data by adding new conditions specified by the user or by tightening existing conditions. The server may then regenerate a new prompt sentence that reflects the updated constraint data and may request the generative AI model to generate revised draft text data. By maintaining structured goal data and constraint data across iterations, the server improves stability and convergence of the refinement process and reduces redundant computations.

From a technical perspective, the server improves computer technology in several ways. The server transforms unstructured natural language into structured representations and feature vectors that can be efficiently indexed and queried. The server reduces communication load with the generative AI model service by caching feature vectors and constraint data and by narrowing the scope of each prompt sentence to relevant aspects derived from similarity search results. The server improves processing speed by avoiding repeated retrieval and analysis of the same normative information; once the server stores constraint data for a goal, later iterations reuse this data with incremental updates. The server improves accuracy and consistency of generated drafts by imposing machine-readable constraints and by systematically verifying outputs against an internal normative database before presentation to the user. The server reduces error rates in generated drafts by using contradiction candidates and rule-based correction processes that are not available in purely manual workflows.

The server uses data structures that are specifically designed for these tasks. The server stores structured goal data in a record format that includes fields for objectives, constraints, entities, and references to normative texts. The server stores feature vectors in a multidimensional index compatible with approximate nearest neighbor algorithms, which allows sublinear-time similarity search over large corpora. The server stores constraint data as a set of predicates and links these predicates to portions of normative texts via identifiers. The server maintains a prompt-construct history that records which elements of constraint data and structured goal data were used in each prompt sentence, which improves auditability and allows targeted debugging of generation failures.

By using these data structures and modules, the server performs more than a mere automation of human drafting. The server employs non-conventional steps, such as generating constraint data through systematic comparison of feature vector-based similarity search results and applying this constraint data to build controlled prompt sentences and to verify model outputs. Human drafters do not ordinarily perform high-dimensional similarity searches or maintain machine-readable constraint graphs when drafting texts. The server's workflow therefore uses computational techniques that are fundamentally different from standard human reasoning and yields technical effects such as reduced latency in retrieval of relevant prior texts, lower memory bandwidth consumption through compact vector representations, and improved cache locality due to repeated use of structured goal data.

Alternative embodiments are possible. The server may execute the generative AI model locally on specialized hardware such as graphics processing units or tensor processing units instead of calling an external service. The server may implement the embedding generation module with different neural architectures, such as convolutional neural networks or recurrent neural networks, and may use alternative distance metrics in the similarity search module.

The server may represent constraint data using logic programming constructs or graph databases instead of relational tables. The server may integrate additional verification modules that use symbolic reasoning or model checking to detect conflicts between draft texts and normative rules.

In another embodiment, the server manages multiple terminals operated by multiple users and maintains separate structured goal data and constraint data for each user or project. The server may prioritize processing of goals based on system load and may schedule similarity searches and generative AI model requests accordingly. The server may compress stored feature vectors using dimensionality reduction techniques to reduce storage requirements and increase retrieval speed.

Thus, the server, the terminal, and the user cooperate in a system that performs specific, structured computations using defined data structures and algorithms. This configuration improves the functioning of the computer system itself by enabling faster, more accurate, and more resource-efficient generation and refinement of complex normative texts, beyond mere automation of known human drafting practices.

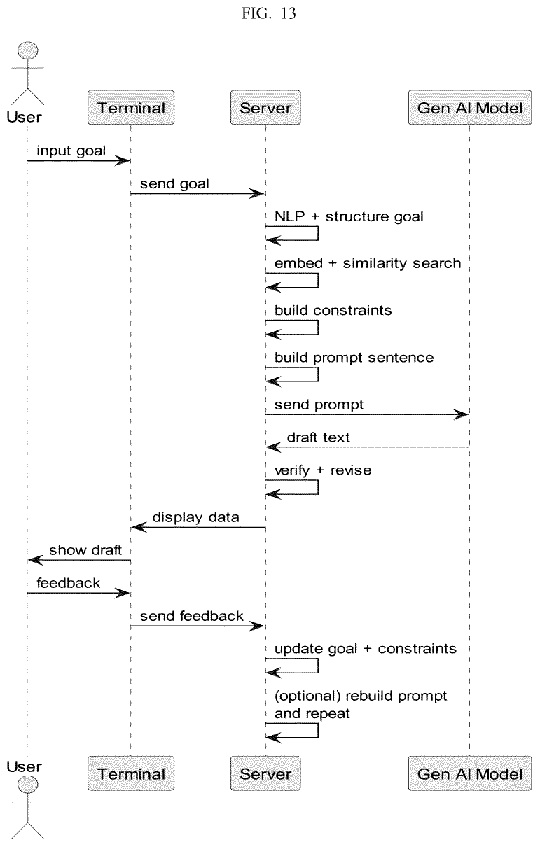

The following describes the processing flow using FIG. 13.

### Step 1:

User operates the terminal to input a goal in natural language.

User types a goal, such as a desired legislative or regulatory objective, into an input field displayed on the terminal.

Terminal receives the character sequence as input, converts it into text data encoded in a character encoding format, and stores the text data in a local buffer.

Terminal generates a request message including the text data and metadata such as a user identifier and a timestamp, and outputs the request message to a communication interface for transmission to the server.

### Step 2:

Server receives the request message from the terminal and extracts the text data.

Server takes the request message as input, parses a message header, verifies authentication information, and decodes the text data portion into an internal string representation.

Server stores the text data in a memory region associated with a newly generated goal identifier and outputs a stored record comprising the goal identifier and the text data.

### Step 3:

Server executes natural language processing on the text data to generate structured goal data.

Server takes the text data as input, loads a natural language processing model into main memory, and performs tokenization, part-of-speech tagging, dependency parsing, and named entity recognition on the text data.

Server applies parsing algorithms to compute syntactic dependencies and identifies key tokens such as verbs, objects, and jurisdiction entities.

Server aggregates these analysis results into a structured representation that includes fields such as objective, sub-objectives, constraints, target entities, and jurisdiction, and outputs structured goal data stored in an internal data structure linked to the goal identifier.

### Step 4:

Server generates a feature vector from the text data and/or the structured goal data.

Server takes as input the structured goal data and optionally the original text data, converts them into a normalized token sequence, and feeds the token sequence into an embedding generation model.

Server performs a series of matrix multiplications and non-linear transformations defined by the model parameters to map the token sequence into a high-dimensional numerical vector.

Server normalizes the resulting vector, for example by L2-normalization, and outputs the feature vector, which is stored in a feature vector index associated with the goal identifier.

### Step 5:

Server performs a similarity search using the feature vector to retrieve related normative and proposal information.

Server takes the feature vector as input and accesses a storage device containing previously stored feature vectors for normative information and proposal information.

Server computes similarity scores, for example cosine similarity, between the input feature vector and stored feature vectors, and ranks stored items according to the similarity scores.

Server selects items whose similarity scores exceed a predefined threshold or belong to a top-k set, retrieves corresponding normative texts and proposal texts from the storage device, and outputs a collection of retrieved texts and associated metadata.

### Step 6:

Server derives constraint data by comparing the structured goal data with retrieved information.

Server takes as input the structured goal data and the collection of retrieved normative texts and proposal texts.

Server converts each retrieved text into an internal representation, such as a set of clauses labeled with rule types (obligation, permission, prohibition) using pattern-matching and rule-based parsing.

Server compares these clauses with elements in the structured goal data to detect conditions that must be satisfied and potential contradictions, such as attempts to permit actions already prohibited by existing norms.

Server encodes the detected conditions as consistency conditions and encodes potential conflicts as contradiction candidates, organizes them into a constraint data structure, and outputs constraint data indexed by the goal identifier.

### Step 7:

Server constructs a prompt sentence for a generative AI model based on the structured goal data and the constraint data.

Server takes as input the structured goal data, the constraint data, and optionally summaries of the retrieved texts.

Server loads a prompt template, inserts the main objective, sub-objectives, and jurisdiction into designated template positions, and appends instructions derived from consistency conditions and contradiction candidates as explicit constraints.

Server formats the prompt sentence to include a role description, requirements list, and output format specification.

Server outputs the constructed prompt sentence as a text string associated with the goal identifier.

### Step 8:

Server transmits the prompt sentence to the generative AI model and obtains draft text data.

Server takes the prompt sentence as input, composes a request message including the prompt sentence and generation parameters such as maximum token count and sampling temperature, and sends the request message through a communication interface to the generative AI model.

Generative AI model processes the prompt sentence and returns a response comprising generated tokens that form a draft text.

Server receives the response as input, decodes the generated tokens into text data, and outputs draft text data linked to the goal identifier and the prompt sentence.

### Step 9:

Server verifies the draft text data using the constraint data and the normative database.

Server takes as input the draft text data, the constraint data, and normative texts stored in the storage device.

Server segments the draft text into structural units such as sections and articles, and maps these units to the internal representation used for normative clauses.

Server checks each unit against consistency conditions, and tests potential conflicts against existing normative clauses indicated by the constraint data.

Server marks units that violate conditions or match contradiction candidates, and applies correction rules which may delete, amend, or add text to resolve specific conflicts.

Server outputs revised draft text data in which noncompliant portions are modified or annotated.

### Step 10:

Server generates display data from the revised draft text data and sends it to the terminal.

Server takes revised draft text data as input and applies formatting rules to insert structural markers, headings, numbering, and layout annotations suitable for display.

Server may generate both a detailed view and a summary view, and may embed metadata such as links to referenced normative texts.

Server packages the formatted content into a response message, outputs the response message through the communication interface, and transmits it to the terminal.

### Step 11:

Terminal receives the display data and renders the revised draft text for the user.

Terminal takes the response message as input, parses the message to extract formatted content, and maps layout annotations to user interface elements.

Terminal draws headings, paragraphs, and lists on the display device, and may highlight portions corresponding to modifications or constraints.

Terminal outputs a visual representation of the revised draft text to the user and accepts further user interactions such as scrolling, selecting sections, or entering feedback.

### Step 12:

User provides feedback or correction requests based on the displayed revised draft text.

User reviews the contents on the terminal and may input evaluation information or correction request information, such as additional conditions, desired changes to specific sections, or approval or rejection of certain provisions.

Terminal takes user inputs as input data, encodes them as feedback information structured with references to relevant sections or articles of the draft, and outputs a feedback message to the server through the communication interface.

### Step 13:

Server updates structured goal data and constraint data based on feedback information and prepares for further refinement.

Server takes the feedback information as input, identifies references to specific parts of the revised draft text or to specific objectives, and maps these references back to the structured goal data and the constraint data.

Server augments the constraint data to include new conditions, removes obsolete contradiction candidates that have been resolved, and adjusts weighting or priority among objectives if specified.

Server updates the structured goal data to reflect any newly added objectives or constraints, and outputs updated structured goal data and updated constraint data associated with the goal identifier, which can be used as input for regenerating a prompt sentence in a subsequent iteration.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems that assist in drafting rules, policies, or legal documents typically rely on static templates, simple keyword search, or manual expert input. Such systems are poorly suited for handling large, heterogeneous corpora of rule information originating from multiple jurisdictions or organizations, and they do not scale well as the volume and complexity of such information increases. As a consequence, the processor of a conventional system is not able to efficiently compute and maintain a machine-usable semantic representation of existing rule information, and thus cannot reliably detect subtle inconsistencies or contradictions between newly generated drafts and existing rule sets.

Further, in many existing systems, the interaction between a drafting support engine and a generative AI model is limited to a one-shot or loosely coupled call, in which a user's goal is passed as a plain natural-language string. The processor in such systems is not configured to systematically construct and iteratively refine structured prompt sentences that include pre-analyzed rule summaries, contradiction context, and user emotion information. As a result, the generative AI model is under-utilized as a computing resource, leading to outputs that are unstable in quality, difficult to control, and not well aligned with the constraints and semantics of the underlying rule corpus.

Moreover, conventional contradiction checking is often implemented as a separate manual review step or as a simple string-based comparison. This approach is computationally inefficient and inaccurate when applied to large-scale corpora of rule information. The processor of a conventional system does not maintain vectorized semantic representations for both existing rule information and generated proposals, and therefore cannot perform similarity calculations and difference calculations in a vector space to systematically detect contradiction candidates and drive automated correction.

Additionally, existing systems that attempt to take user preferences into account typically do so through ad hoc settings or profile flags. They are not configured to estimate emotion information from multi-modal user input (text, audio, image) and to feed that emotion information back into the generative AI model as a first-class parameter. Consequently, such systems cannot dynamically adapt the expression intensity, regulation strength, or support conditions in prompt sentences and generated outputs in a way that reflects a user's emotional state while maintaining technical consistency with existing rules.

These limitations mean that, from the viewpoint of computer technology, the processing pipeline from rule corpus acquisition, semantic learning, generative AI interaction, contradiction detection, automated correction, impact prediction, and emotion-aware amendment remains fragmented, manual, and inefficient. There is a need for a computer-implemented technique in which a processor cooperates with a generative AI model through machine-constructed prompt sentences, uses vector-space semantic representations to compute contradiction candidates and corrections, and uses emotion information as a computational parameter, thereby improving the technical operation of the drafting support system itself, including processing efficiency, controllability of outputs, and robustness of consistency checking.

The specific processing by the specific processing unit 290 of the data processing device 12 in Application Example 2 is realized by the following means.

The present invention provides a server comprising a processor configured to acquire rule information from an information storage device, perform language analysis and feature extraction on the rule information to generate semantic representations, store the semantic representations as learning data, obtain objective information and emotion information from a user, construct a prompt sentence including summary information of relevant rule information for instructing a generative AI model to generate a rule proposal or a policy proposal, input the prompt sentence and the summary information to the generative AI model to obtain the rule proposal or the policy proposal, divide the obtained proposal into component elements, generate semantic representations for the component elements, perform similarity calculation and difference calculation between the semantic representations of the component elements and the semantic representations of the rule information in a vector space to extract contradiction candidates, generate correction information for modifying the proposal to resolve the contradiction candidates, generate impact prediction information based on the correction information and the emotion information, when the impact prediction information conflicts with the emotion information and the objective information reconstruct a prompt sentence for instructing the generative AI model to generate an amendment proposal and obtain the amendment proposal, and output the proposal, the correction information, and the amendment proposal to a user terminal while updating the prompt sentence based on evaluation information or additional input information from the user terminal. This enables the server to operate as an improved computing platform that (i) efficiently encodes large-scale rule corpora into machine-usable semantic vectors, (ii) programmatically controls interactions with the generative AI model via structured prompt sentences, (iii) automatically detects and resolves contradiction candidates through vector-space computations, and (iv) dynamically adjusts generated proposals in response to user emotion, thereby enhancing the consistency, responsiveness, and technical performance of computer-implemented drafting support for rules and policies.
The term “rule information” refers to information representing rules, regulations, laws, ordinances, internal policies, standards, or other normative texts that define obligations, permissions, prohibitions, procedures, or guidelines in a social, organizational, or technical context.
The term “information storage device” refers to any hardware or logical storage resource configured to store data, including but not limited to a database system, a file system, a storage array, or a cloud-based storage service.
The term “language analysis processing” refers to processing that analyzes character string data as natural language, including at least one of tokenization, morphological analysis, syntactic analysis, semantic parsing, or named-entity recognition.
The term “feature extraction processing” refers to processing that derives structured attributes from rule information, including keywords, phrases, entities, metadata, numerical features, or other machine-usable descriptors.
The term “semantic representation” refers to a machine-usable representation that encodes the meaning of rule information or proposal content, including but not limited to a vector representation, an embedding, or a structured symbolic representation.
The term “learning data” refers to data prepared for training, updating, or adapting a model, classifier, or other computational function, including semantic representations, labels, and associated metadata.
The term “objective information” refers to information that expresses a user's goal, intent, or target outcome to be achieved by a rule proposal or policy proposal, typically provided as natural-language input.
The term “emotion information” refers to information indicating an estimated emotional state of a user, such as anger, fear, sadness, anxiety, satisfaction, or other affective state, including associated intensity or confidence levels.
The term “prompt sentence” refers to a text sequence, which may be a single sentence or multiple sentences, constructed to instruct a generative AI model to perform a particular output task, and which may include context, constraints, examples, or user-related parameters.
The term “summary information” refers to information that represents a condensed form of rule information, including abstracts, key clauses, extracted passages, or other reduced content derived from the original rule information.
The term “rule proposal” refers to generated content that describes a candidate set of rules, regulations, or legal-like provisions intended to be newly created or revised, including articles, sections, or clauses.
The term “policy proposal” refers to generated content that describes a candidate policy, guideline, or internal standard for an organization, including provisions, procedures, or recommendations.
The term “generative information processing model” refers to a computational model, including a generative AI model or a large language model, that is configured to generate text, proposals, or other outputs based on input data such as a prompt sentence.
The term “component element” refers to a unit obtained by dividing a rule proposal or a policy proposal, such as an article, a section, a paragraph, a clause, or another logical subpart.
The term “data structure” refers to a structured arrangement of data in memory or storage, such as a list, tree, graph, record, table, or other representation that organizes component elements and associated attributes.
The term “similarity calculation” refers to a computation that measures a degree of similarity between two or more semantic representations, such as by using cosine similarity, distance metrics, or correlation measures.
The term “difference calculation” refers to a computation that identifies or quantifies differences between two or more semantic representations or texts, including but not limited to vector differences, set differences, or text-diff operations.
The term “contradiction candidate” refers to a portion of a rule proposal or policy proposal that is identified, based on semantic comparison, as potentially inconsistent, conflicting, or incompatible with existing rule information.
The term “correction information” refers to information that specifies modifications to a rule proposal or policy proposal, such as revised wording, added conditions, or deletions, for the purpose of resolving contradiction candidates.
The term “impact prediction information” refers to information that represents a predicted impact degree or effect of a rule proposal or policy proposal, such as estimated changes in behavior, cost, risk, compliance level, or affected populations.
The term “amendment proposal” refers to a generated proposal for amending an existing rule proposal or policy proposal, including revised articles, additional provisions, or alternative formulations intended to improve alignment with constraints or objectives.
The term “user terminal” refers to a computing device operated by a user, such as a client computer, a mobile device, or another interface device, that is configured to send input to and receive output from the server.
The term “evaluation information” refers to information indicating a user's assessment of a rule proposal, policy proposal, correction information, or amendment proposal, including approvals, rejections, comments, or preference indications.
The term “additional input information” refers to further information provided by a user after an initial proposal is generated, including revised goals, constraints, comments, or explicit modification requests.
The term “vector space” refers to a mathematical space in which semantic representations are expressed as numerical vectors, enabling linear algebra operations such as similarity computation and difference computation.
The term “numerical data” refers to data expressed as numbers, arrays, or tensors, including vectorized representations of semantic information suitable for machine computation.
The term “correction instructions” refers to instructions included in a prompt sentence that direct the generative information processing model to modify a proposal to resolve identified contradiction candidates.
The term “emotion estimation processing” refers to processing that infers emotion information from input data, such as by analyzing character string information, audio information, or image information using classification or regression techniques.
The term “character string information” refers to textual data composed of characters, symbols, or code points, including user-entered natural-language text.
The term “audio information” refers to sound data, including digitized speech signals or other acoustic signals obtained from a user.
The term “image information” refers to visual data, including still images or video frames that may contain representations of a user or contextual scenes.
The term “expression intensity” refers to a degree or strength of expression used in generated text, such as strictness, emphasis, or assertiveness of wording.
The term “regulation strength” refers to a degree of restrictiveness, obligation, or enforcement level expressed in a rule proposal or policy proposal.
The term “support measures” refers to provisions, conditions, or mechanisms in a proposal that provide assistance, mitigation, benefits, or protections for affected entities or individuals.
The term “emotional state of the user” refers to the current affective condition of the user as represented in emotion information, including type of emotion and its intensity, at a relevant time during system operation.

In one embodiment, a server, a terminal, and a network cooperate to implement the claimed system. The server comprises at least one processor, a memory, a non-transitory storage device, and a network interface. The server executes software modules that implement rule information acquisition, language analysis, feature extraction, semantic representation generation, vector-space similarity and difference calculation, prompt sentence construction, interaction with a generative AI model, contradiction detection and correction, impact prediction, emotion estimation handling, and user feedback processing. The terminal comprises a processor, a display, an input unit, and a communication interface, and executes a client application for user interaction.

The server executes an operating system such as a general-purpose server operating system, and application software implemented in a programming language such as a high-level scripting language. The server stores rule information in a database management system, such as a relational database. The server uses natural language processing libraries, such as a tokenization and parsing toolkit and a syntactic/semantic analysis toolkit, to perform language analysis processing and feature extraction processing. The server uses a machine learning framework, such as a deep learning library, to implement neural network based embedding models and to perform training and inference. The server communicates with an external generative AI model via an application programming interface exposed by a remote inference service or, in another embodiment, executes a locally deployed generative AI model on hardware accelerators such as graphics processing units.

The server acquires rule information from an information storage device that may include external legal databases, internal policy repositories, and regulatory archives. The server uses structured query language to retrieve rule texts and associated metadata. The server normalizes character encoding and stores raw rule texts in a normalized text table. The server then performs language analysis processing to decompose each rule text into tokens, sentences, and syntactic structures. The server uses part-of-speech tagging, dependency parsing, and named-entity recognition to extract feature information, such as legal concepts, entities representing organizations, regulated activities, thresholds, and penalty types. The server maps such features into a feature vector space by using embedding layers in a neural network.

In one embodiment, the server implements a sentence-level embedding model based on a transformer architecture. The server constructs the model with multiple self-attention layers, feed-forward layers, and normalization layers. The server defines an input embedding layer that converts tokens into continuous vectors, and defines positional encoding parameters. The server pre-trains the embedding model on a large corpus of rule information using a masked language modeling objective and next-sentence prediction or contrastive learning objectives. The server then fine-tunes the model on task-specific data by minimizing a loss function such as cross-entropy loss or triplet loss, using backpropagation and an optimization algorithm such as Adam. The server updates weight parameters stored in memory by computing gradients and applying learning-rate schedules. This training process produces semantic representations in the form of high-dimensional numerical vectors that capture similarity relationships between rule texts more effectively than conventional keyword-based indexing.

The server stores the semantic representations of rule information in a vector index structure. In one example, the server uses an approximate nearest neighbor index to accelerate similarity search in high-dimensional vector space. The server associates each semantic representation with identifiers of the corresponding rule entries and with metadata such as jurisdiction, date, and classification tags. By doing so, the server improves data management and retrieval performance compared to systems that rely solely on string matching.

The user uses the terminal to input objective information. The terminal displays an input field on a graphical user interface, and the user inputs a goal such as “I want to draft a new law to reduce cyber attacks while respecting privacy” or “Create an internal data protection policy that complies with major privacy regulations.” The terminal transmits the objective information as text to the server. In addition, the user may provide speech or video data, and the terminal may transmit such audio or image information to the server or may perform local preprocessing.

The server obtains emotion information related to the objective information. In one embodiment, the server performs emotion estimation processing on character string information by using a text classification model implemented in a neural network. The server tokenizes the user input and passes token sequences through an encoder network that outputs an emotion label distribution. The server defines an output layer with a softmax activation and trains the network with labeled examples of emotional text, minimizing cross-entropy loss between predicted emotion distributions and ground-truth labels. The server thereby computes emotion information such as “strong anger,” “sadness,” or “anxiety.” In another embodiment, the terminal executes an emotion estimation model for audio information or image information, such as a convolutional neural network for facial expression recognition or a recurrent network for speech prosody analysis, and transmits the resulting emotion information to the server.

The server constructs a prompt sentence for a generative AI model based on the objective information, the emotion information, and rule information. The server first selects relevant rule information by computing vector-space similarity between the semantic representation of the objective information and semantic representations of stored rule texts. The server performs cosine similarity calculation or equivalent vector-based distance calculation and ranks rule entries by similarity score. The server then extracts summary information from the top-ranked rule entries. In one embodiment, the server uses a sequence-to-sequence model to produce abstractive summaries of rule texts, trained with an encoder-decoder architecture on a corpus of rule-summary pairs. In another embodiment, the server uses extractive summarization based on scoring of sentences via attention weights or regression models and selecting high-scoring sentences.

The server merges the objective information, the emotion information, and the summary information into a structured prompt sentence. For example, the server may generate a prompt sentence as follows:
“You are a legal drafting assistant.

The user's goal is to draft a new law to reduce cyber attacks while respecting privacy.

Relevant existing rules include the following summarized provisions: [summary of data security obligations, privacy protections, and enforcement mechanisms].

The user currently feels anxiety about privacy risks.

Based on the above, propose a structured draft law with numbered articles that strengthens cyber security while avoiding conflicts with existing privacy rules and taking into account the user's privacy concerns.”

In another example for corporate policy, the server may construct a prompt sentence: “The organization's goal is to create an internal data protection policy that complies with major privacy regulations.

Relevant existing rules include key requirements on consent, data subject rights, retention limits, and breach notification.

Employees are anxious about intrusive monitoring.

Draft a detailed internal policy that enforces strong protection of personal data and defines access controls and logging, while minimizing perceived surveillance and maintaining compliance with the referenced rules.”

By algorithmically composing prompt sentences that incorporate semantic rule summaries and emotion information, the server improves control over the behavior of the generative AI model. This control is not achievable by merely forwarding the raw user text, and it results in more stable and consistent outputs.

The server inputs the constructed prompt sentence and the associated summary information into the generative AI model. In one embodiment, the server calls a remote large language model via an application programming interface. The server sends the prompt sentence as part of a request payload and receives generated text as response data. The generative AI model internally implements a transformer-based neural network with multiple layers, self-attention heads, and large parameter counts, pre-trained on a large corpus of textual data using next-token prediction or similar autoregressive objectives. In another embodiment, the server executes a locally hosted generative AI model on a graphics processing unit, using the same type of transformer architecture.

The server receives the generated rule proposal or policy proposal from the generative AI model and stores the text as proposal data. The server divides the proposal into component elements, such as articles or sections, by using rule-based segmentation on headings and numbering. The server generates semantic representations for each component element by passing the element text through the previously described embedding model. This produces vector representations for individual articles or clauses.

The server performs similarity calculations and difference calculations between the semantic representations of the component elements and the semantic representations of existing rule information. The server uses vector arithmetic to compute cosine similarity values and uses threshold-based rules to detect potential semantic overlap or conflict. Additionally, the server applies difference calculation methods, such as vector subtraction and distance evaluation, and text comparison algorithms such as diff algorithms, to detect provisions that may contradict or duplicate existing rules. The server identifies such matches as contradiction candidates.

The server generates correction information for contradiction candidates. In one embodiment, the server applies non-conventional rule-based logic that enforces stricter interpretations when conflicts are detected. For example, when two rules specify different retention periods, the server automatically selects the stricter period based on a numeric comparison of extracted duration values and constructs correction text to harmonize the rule proposal with the stricter requirement. In another embodiment, the server constructs a secondary prompt sentence describing the detected contradiction and instructs the generative AI model to rewrite a specific article. For example, the server may generate the following prompt sentence:
“Article 5 of the generated draft requires retaining user data for 10 years.

Existing privacy rules in the same domain require deleting or anonymizing personal data after 3 years.

Rewrite Article 5 so that it complies with the 3-year retention limit while preserving the goal of effective cyber security.”

The server then receives revised text from the generative AI model and replaces the conflicting component element accordingly. By combining vector-space contradiction detection with prompt-based rewriting, the server executes a non-traditional pipeline that reduces manual review load and improves the internal consistency of the proposal.

The server additionally generates impact prediction information based on the corrected proposal and the emotion information. The server extracts structured features from component elements, such as threshold values, penalty magnitudes, and scope variables. The server uses predictive models or rule-based simulations to estimate metrics such as expected reduction in incidents, implementation cost, or number of affected entities. The server then compares these predicted impacts with the emotion information and objective information. For instance, if the predicted impact indicates significant hardship on a vulnerable group and the emotion information indicates sadness about such hardship, the server determines that further amendments are desirable.

In response, the server reconstructs a new prompt sentence for an amendment proposal. The server embeds the predicted impact, the user's emotional state, and specific articles into the prompt. For example, the server may formulate:
“The current draft is predicted to reduce crime but to increase financial hardship for low-income individuals.

The user feels sadness about this hardship.

Revise Articles 8 and 9 to add support measures for low-income individuals, such as subsidies or assistance programs, while maintaining the crime-reduction objectives and avoiding conflicts with existing rules.”

The server inputs this prompt sentence into the generative AI model and receives an amendment proposal that adds or modifies provisions. The server again analyzes semantic representations and contradiction candidates for the amended parts to ensure consistency.

The server outputs the rule proposal, the correction information, and the amendment proposal to the terminal. The terminal displays the proposals in a structured interface where the user can view the full text, see highlighted contradictions and their corrections, and inspect impact prediction summaries. The user provides evaluation information or additional input information, such as comments on specific articles or requests for stronger or weaker regulation. The terminal sends such feedback to the server, and the server updates subsequent prompt sentences based on this feedback, thereby refining future proposals.

This configuration improves computer technology in several ways. First, by using semantic representations and vector-space operations rather than simple string search, the server significantly reduces retrieval time and increases accuracy in identifying relevant rules and contradiction candidates in large corpora. This improves processing speed and reduces error rates in consistency checking. Second, by constructing prompt sentences that embed structured semantic context, contradiction context, and emotion information, the server exerts fine-grained control over the generative AI model's behavior, resulting in more predictable and controllable outputs. This is not a mere automation of human drafting; it is an adaptation of the generative model's internal inference path by feeding it machine-crafted input that reflects computed semantic structures, which is a technical improvement in model utilization.

Third, the server employs non-conventional processing steps that integrate vector similarity, structured feature extraction, and neural-network based emotion estimation into a single pipeline. The server's internal modules exchange data via well-defined data structures, such as vectors, tables of component elements, and metadata records, and these structures support efficient computational operations. The system thus achieves reduced communication load between modules by passing compact vector representations rather than raw texts where possible. Fourth, the use of neural network architectures with specifically defined training objectives, loss functions, and optimization procedures allows the server to learn rule semantics and emotional cues in a way that improves the precision of similarity measures and emotion estimates over time, thus further improving performance.

In alternative embodiments, the server may use different types of generative AI models, such as encoder-decoder models or mixture-of-experts architectures, and may adjust the number of attention heads, depth of layers, and embedding dimensions to meet computational resource constraints. The server may store semantic representations in alternative data structures, such as graph databases representing relationships between rules and proposals, and may use graph neural networks for similarity and contradiction detection. In another embodiment, the terminal may perform some language analysis or emotion estimation locally to reduce network traffic, and the server may only receive pre-processed feature vectors. In yet another embodiment, the system may be configured to control external devices, such as compliance monitoring systems or automated configuration tools, by transforming approved proposals into machine-readable policies that drive configuration updates on network devices, thereby tying the abstract drafting process to concrete device control.

Across these embodiments, the server, the terminal, and the user cooperate to implement a system in which generative AI model interactions, prompt sentence construction, semantic representation generation, contradiction detection, and emotion-aware amendment form a tightly integrated computing workflow. This workflow operates according to specific algorithms and data structures that improve the speed, accuracy, and robustness of rule and policy drafting beyond what can be achieved by human drafters or by conventional computer systems that lack such semantic and vector-based processing capabilities.

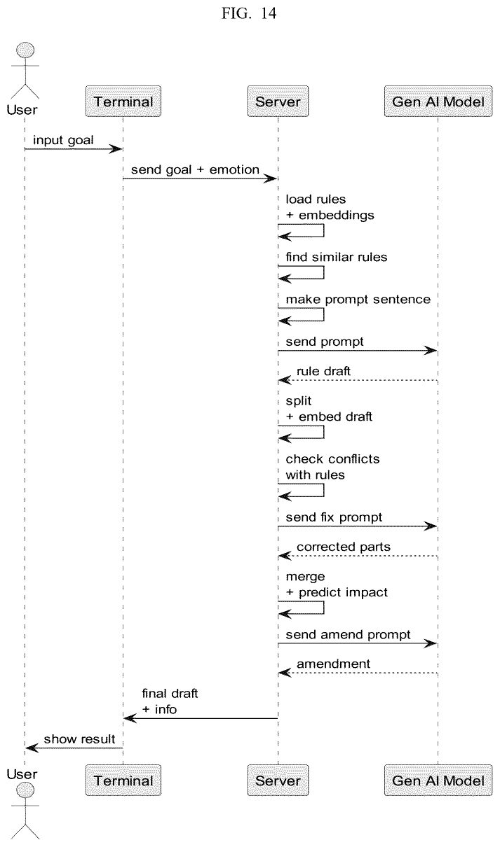

The following describes the processing flow using FIG. 14.

### Step 1:

The server acquires rule information from an information storage device.

The server receives as input connection parameters, such as database URLs, authentication credentials, and table names. The server executes structured queries to retrieve rule texts and metadata, and normalizes character encoding to a common format. The server performs data processing to remove control characters and to convert the raw texts into a standardized record structure. The server outputs a collection of normalized rule records, each including textual content and associated metadata, and stores these records in a rule information table.

### Step 2:

The server performs language analysis processing and feature extraction processing on the rule information.

The server receives as input the normalized rule records from Step 1. The server applies tokenization, sentence splitting, part-of-speech tagging, dependency parsing, and named-entity recognition by using natural language processing software. The server computes data operations that map sequences of tokens to syntactic structures and extracts feature sets such as key terms, entities, numerical values, and section headings. The server outputs feature-enriched rule records, in which each rule text is associated with structured feature fields, and stores these enriched records in a feature table.

### Step 3:

The server generates semantic representations of the rule information.

The server receives as input the feature-enriched rule records from Step 2. The server encodes the rule texts as token sequences and feeds them into a neural network embedding model implemented with a machine learning framework. The server performs matrix multiplications, attention-weight calculations, and non-linear activations through multiple layers of the model to produce high-dimensional vectors. The server outputs semantic representation vectors for each rule record and stores these vectors, together with rule identifiers, in a vector index structure.

### Step 4:

The server indexes semantic representations for efficient similarity search.

The server receives as input the semantic representation vectors from Step 3. The server builds an index structure, such as an approximate nearest neighbor index, and inserts each vector into the index by computing hash keys or partition assignments. The server performs data operations that optimize storage layout and precompute auxiliary statistics for distance calculations. The server outputs an initialized vector index that supports fast similarity queries for later processing.

### Step 5:

The user inputs objective information by using the terminal.

The user provides as input a natural language description of a goal, such as a desired law or policy, via an input field on the terminal. The terminal receives this text and may also receive an optional category selection. The terminal performs basic validation, such as checking for minimum length and disallowed characters. The terminal outputs a structured objective message that includes the goal text and optional category information and transmits this message to the server over a network connection.

### Step 6:

The terminal optionally obtains emotion information from user input.

The terminal receives as input the user's textual goal and, in some embodiments, audio or image data. The terminal executes a local emotion estimation model or calls an external emotion analysis service to classify the emotional state, performing feature extraction (e.g., text embeddings, audio spectral features, or facial landmarks) and classification computations. The terminal outputs emotion information such as an emotion label and intensity score and includes this information in a message to the server.

### Step 7:

The server parses the objective information and emotion information.

The server receives as input the structured objective message and, if present, the emotion information from the terminal. The server performs tokenization, part-of-speech tagging, and entity extraction on the objective text to derive objective-related features. The server combines the parsed objective features with the emotion label and intensity by storing them in a session-specific data structure. The server outputs a goal representation that encapsulates the parsed objective information and the associated emotion information for use in later steps.

### Step 8:

The server computes a semantic representation of the objective information.

The server receives as input the goal representation from Step 7. The server encodes the objective text as a token sequence and feeds the sequence into the same or a compatible embedding model used in Step 3. The server performs the neural network computations to map the sequence to a single vector, using attention pooling or a special classification token embedding. The server outputs an objective vector that represents the semantic meaning of the user's goal.

### Step 9:

The server retrieves similar rule information based on vector similarity.

The server receives as input the objective vector from Step 8 and the vector index from Step 4. The server issues a similarity query to the index, computing approximate or exact nearest neighbors by distance metrics such as cosine distance. The server performs data operations that rank candidate rule vectors by similarity score. The server outputs a ranked list of rule identifiers together with similarity scores and retrieves the corresponding rule texts and features from the database.

### Step 10:

The server generates summary information of relevant rule information.

The server receives as input the retrieved rule texts and features from Step 9. The server uses a summarization algorithm, such as an encoder-decoder model or a scoring-based sentence selection method, to compress each rule text into a shorter representation. The server performs data processing that computes attention weights, sentence scores, or decoded summary sentences. The server outputs summary information for each selected rule, and stores this summary information in association with the original rule identifiers in a summary table.

Step 11:

The server constructs a structured prompt sentence for a generative AI model.

The server receives as input the objective information, the emotion information, and the summary information from Steps 7, 8, and 10. The server assembles text segments that describe the user's goal, list key summarized rules, and express the detected emotion, and inserts explicit instructions about structure and constraints. The server performs string concatenation, template filling, and, if necessary, length control by truncating less relevant summaries. The server outputs a prompt sentence such as:
“You are a legal drafting assistant.

The user's goal is to draft a new law to reduce cyber attacks while respecting privacy.

Relevant existing rules include the following summarized provisions: [summaries].

The user currently feels anxiety about privacy risks.

Based on the above, propose a structured draft law with numbered articles that strengthens cyber security while avoiding conflicts with existing privacy rules and taking into account the user's privacy concerns.”

### Step 12:

The server prepares a request to the generative AI model.

The server receives as input the constructed prompt sentence from Step 11. The server wraps the prompt sentence into a request format required by the generative AI model service, adding parameters such as maximum output length, temperature, and top-p values. The server performs serialization of the request to a data format suitable for network transmission. The server outputs a complete request message and sends it through a network interface to the generative AI model.

### Step 13:

The server obtains a rule proposal or policy proposal from the generative AI model.

The server receives as input a response message from the generative AI model. The server extracts generated text content from the response and verifies that the content satisfies basic conditions, such as non-emptiness and maximum length. The server performs decoding of the response format and error handling if necessary. The server outputs a raw generated proposal text and stores it as a draft record associated with the corresponding objective.

### Step 14:

The server divides the proposal into component elements.

The server receives as input the raw generated proposal text from Step 13. The server scans the text for headings, numbering patterns, and paragraph breaks and applies parsing rules to segment the text into articles, sections, or clauses. The server performs string pattern matching and structural tagging operations to identify boundaries. The server outputs a list of component elements, each containing a text segment and an identifier indicating its position in the proposal.

### Step 15:

The server generates semantic representations for component elements.

The server receives as input the component elements from Step 14. The server encodes each element's text into token sequences and processes them through the embedding model used in previous steps. The server performs repeated neural network inference operations and outputs a semantic vector for each component element. The server associates each vector with the corresponding component identifier and stores them in a component vector table for later comparison.

### Step 16:

The server detects contradiction candidates between the proposal and existing rule information.

The server receives as input the component vectors from Step 15 and the rule information vectors from Step 3. The server performs similarity calculations by computing distances between component vectors and rule vectors, and applies threshold conditions to identify potentially conflicting or overlapping content. The server further performs difference calculations, including vector subtraction and text diffing for selected pairs, to highlight specific divergences. The server outputs a set of contradiction candidates, each linking a component element to one or more existing rules and describing the nature of the potential contradiction.

Step 17:

The server generates correction information for contradiction candidates.

The server receives as input the set of contradiction candidates from Step 16. For straightforward numeric or definitional conflicts, the server applies rule-based logic that computes corrected values or uniform definitions by comparing conflicting features. For more complex conflicts, the server constructs secondary prompt sentences that describe each contradiction, for example:
“Article 5 of the generated draft requires retaining user data for 10 years, while existing rules require deletion after 3 years. Rewrite Article 5 to comply with the 3-year retention limit while preserving cyber security goals.”

The server inputs such prompt sentences to the generative AI model and receives revised text segments as output. The server outputs correction information that includes updated component text and explanatory metadata.

### Step 18:

The server integrates corrections into the proposal.

The server receives as input the correction information from Step 17 and the original component elements from Step 14. The server replaces or modifies the text of affected component elements according to the correction information. The server performs consistency checks to ensure that cross-references and numbering remain valid. The server outputs an updated proposal in which contradiction candidates have been addressed, and stores this proposal as a corrected draft.

### Step 19:

The server generates impact prediction information for the corrected proposal.

The server receives as input the corrected draft from Step 18. The server extracts specific features from component elements, such as thresholds, penalty values, affected populations, and compliance requirements. The server applies predictive models or rule-based computations to estimate quantitative impacts, such as estimated reduction in incidents or cost measures. The server performs numerical calculations, aggregations, and risk scoring. The server outputs an impact prediction report that summarizes predicted effects and associates the report with the corrected draft.

### Step 20:

The server determines whether the impact prediction aligns with the objective information and emotion information.

The server receives as input the impact prediction report from Step 19, together with the objective information and emotion information from Step 7. The server applies decision logic that compares predicted hardships or benefits with the user's expressed emotional state and goals. The server performs threshold checks and rule evaluations, such as determining if predicted hardship for vulnerable groups exceeds a limit when the user feels sadness about that hardship. The server outputs a decision result indicating whether an amendment is recommended, and if so, which components require amendment.

### Step 21:

The server constructs an amendment prompt sentence for the generative AI model.

The server receives as input the decision result from Step 20, along with the corrected draft and the impact prediction report. For components identified as requiring amendment, the server composes a prompt sentence that describes the current provisions, the predicted negative effect, and the user's emotional concerns. The server performs string assembly operations and may reuse templates such as:
“The current draft is predicted to reduce crime but to increase financial hardship for low-income individuals. The user feels sadness about this hardship. Revise Articles 8 and 9 to add support measures for low-income individuals while maintaining crime-reduction objectives and avoiding conflicts with existing rules.”

The server outputs one or more amendment prompt sentences ready to be sent to the generative AI model.

### Step 22:

The server obtains an amendment proposal from the generative AI model.

The server receives as input the amendment prompt sentences from Step 21. The server transmits these prompt sentences to the generative AI model, performs the same request-response handling as in earlier steps, and receives revised component texts that implement the requested amendments. The server outputs an amendment proposal containing updated or additional articles and stores the amended components in association with the corrected draft.

### Step 23:

The server assembles a final proposal version.

The server receives as input the corrected draft from Step 18 and the amendment proposal from Step 22. The server merges original, corrected, and amended components according to their identifiers, ensuring that the final structure is coherent and that numbering and cross-references are consistent. The server performs a final integrity check and, optionally, a limited contradiction re-check on the modified parts. The server outputs a final proposal version tagged as conflict-checked and emotion-aware.

### Step 24:

The server outputs proposal information to the terminal and receives user feedback.

The server receives as input a request from the terminal to view the latest proposal. The server sends the final proposal version, the correction information, and the impact prediction information as response data. The terminal displays this information to the user, who reviews the contents and may input evaluation information or additional input information, such as comments or requests for further modification. The terminal transmits this feedback to the server. The server receives the feedback and parses it into structured form, and outputs updated prompt parameters or constraints that will be applied in subsequent executions of Steps 11, 17, or 21 for further refinement.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

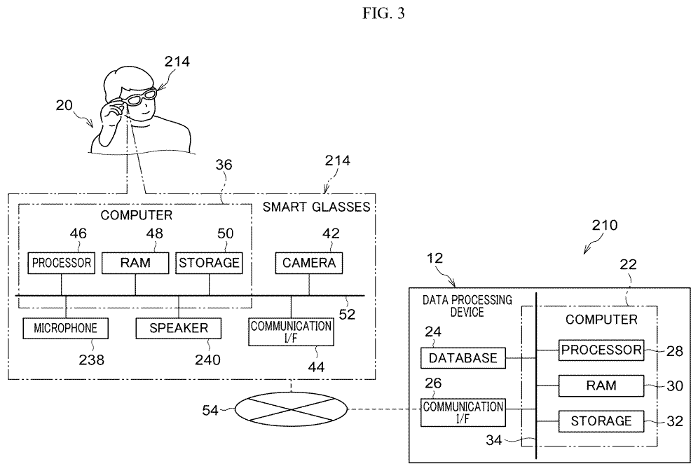

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

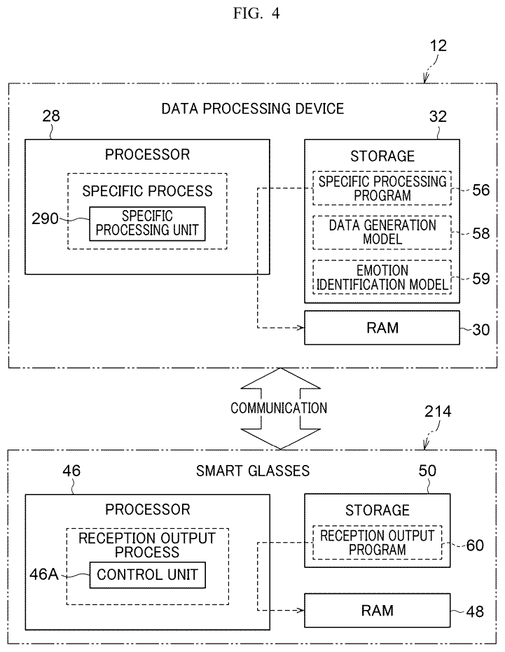

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

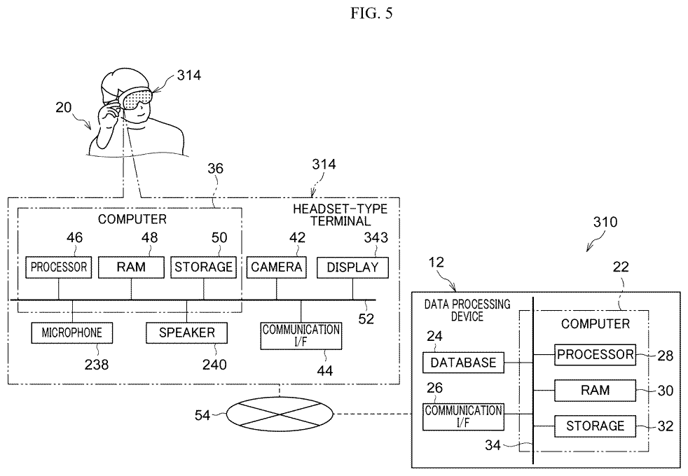

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

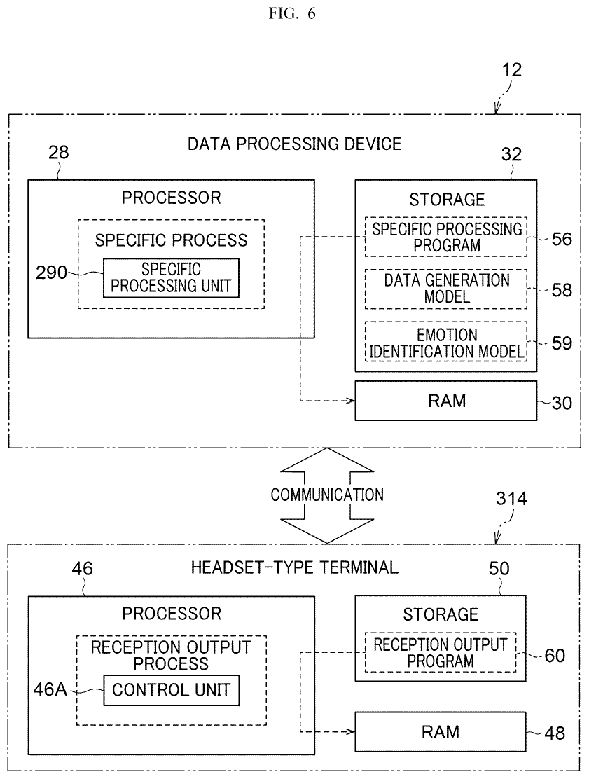

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

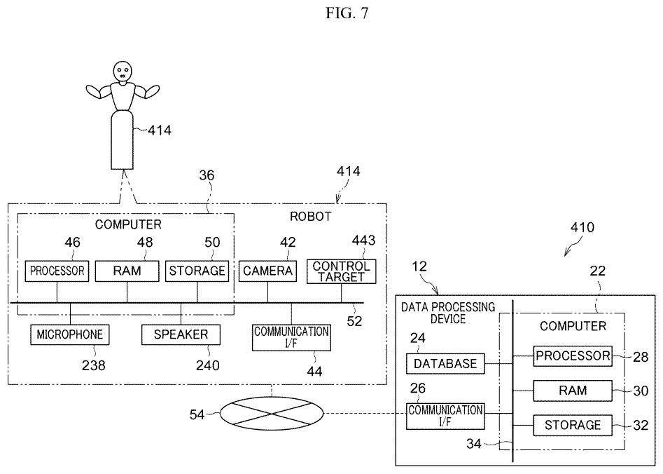

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

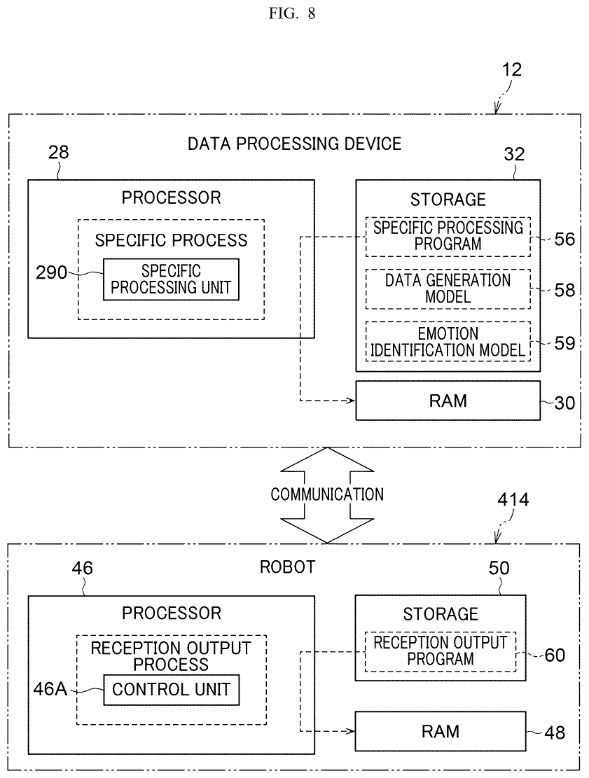

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

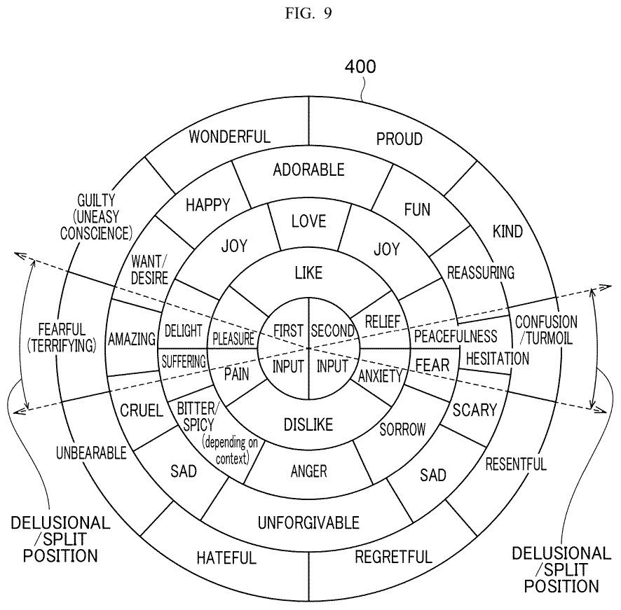

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

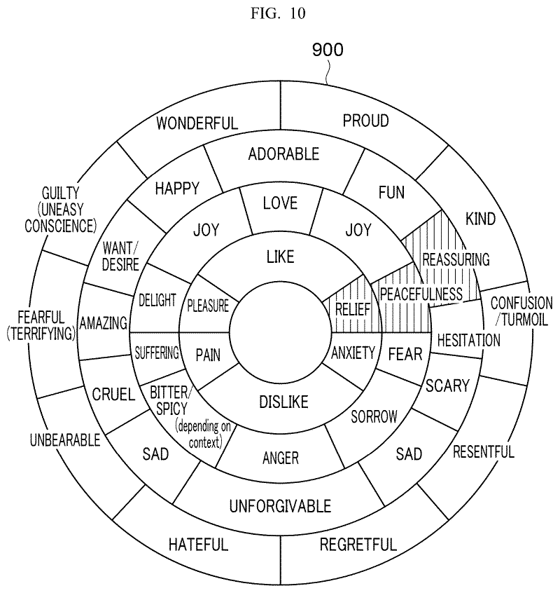

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire regulation information corresponding to a plurality of regions from a storage device,
structure the acquired regulation information, and store the structured regulation information, execute natural language processing on the acquired regulation information to extract linguistic feature information including terms, phrases, sentence structures, and semantic
information, and store the linguistic feature information as an index structure,
train a generative information processing model by performing machine learning processing based on the extracted linguistic feature information and the regulation information, and
construct a trained model that represents contents and mutual relationships of the regulation information,
generate a prompt sentence for causing the generative information processing model to generate a regulation proposal based on objective information input from a user and the trained model, and input the prompt sentence to the generative information processing model to acquire the regulation proposal,
extract related regulation information based on a user input instruction sentence, the trained model, and the regulation information, and provide the related regulation information as input context to the generative information processing model, and
perform natural language generation processing on the regulation proposal output from the generative information processing model to generate a response sentence for presentation to the user.

### Supplementary 2

The system according to supplementary 1,
wherein the processor is configured to
compare the regulation proposal with the regulation information based on the linguistic feature information and the trained model, detect inconsistent elements, and harmonize the regulation proposal by deleting or correcting the inconsistent elements.

### Supplementary 3

The system according to supplementary 1,
wherein the processor is configured to
acquire evaluation information from the user, retrain the generative information processing model and the trained model based on the evaluation information and a relationship between the regulation proposal and the regulation information, and generate a revised regulation proposal again.

### Application Example 1

### Supplementary 1

A system comprising a processor,
wherein the processor is configured to
acquire worldwide legal information from an external information source and analyze the acquired legal information to convert the legal information into learning information, classify and summarize the learning information and store the learning information as structured data representing regulatory matters for each jurisdiction,
acquire current location information of a user from a location acquisition device and identify, based on the current location information, an applicable jurisdiction,
retrieve legal information corresponding to the applicable jurisdiction from the structured data, convert the legal information into plain expressions by using a natural language processing technique, and generate display information that is presentable on a user terminal,
generate a prompt sentence for causing a generative AI model to generate a draft legislation or an explanatory text, the prompt sentence being generated based on goal information input by a legislator or the user and the legal information corresponding to the applicable jurisdiction,
operate the generative AI model by using the prompt sentence and the legal information as inputs and acquire a generated draft legislation or a generated answer text from the generative AI model,
compare the generated draft legislation or the generated answer text with existing legal information stored as the structured data, detect inconsistency or duplication with the existing legal information, and automatically generate correction information for resolving the inconsistency or duplication, and
generate final display information for presentation on the user terminal by using the generated draft legislation or the generated answer text and the correction information.

### Supplementary 2

The system according to supplementary 1,
wherein the processor is configured to
search, based on a question sentence input by the user and the current location information, legal information related to the question sentence, construct a prompt sentence including the question sentence and the related legal information as context information, input the prompt sentence to the generative AI model to cause the generative AI model to generate an answer text for question answering, and transmit the answer text to the user terminal to provide location-dependent legal information in an interactive format.

### Supplementary 3

The system according to supplementary 1,
wherein the processor is configured to
acquire evaluation information or correction request information input by the user, generate a new prompt sentence including the evaluation information or the correction request information and the generated draft legislation or the generated answer text, input the new prompt sentence to the generative AI model again to cause the generative AI model to generate a revised draft legislation or a revised answer text, and store the revised draft legislation or the revised answer text as learning information for updating the structured data and the generative AI model.

### Example 2

### Supplementary 1

A system comprising a processor,
wherein the processor is configured to
obtain a goal expressed in natural language from a terminal operated by a user, and receive the goal as text data from the terminal,
perform natural language processing on the text data using a natural language processing program to execute morphological analysis, syntactic analysis, and phrase extraction, and thereby extract a structure and key concepts of the goal and generate goal information as structured data,
generate a feature vector by applying an embedding generation program to the structured data or the text data to convert the data into a numerical vector, and obtain past normative information or past proposal information from a similarity search storage by performing a similarity search based on the feature vector,
compare the obtained past normative information or past proposal information with the goal information, extract consistency conditions and contradiction candidates with respect to an existing normative system, and organize the consistency conditions and the contradiction candidates as constraint information,
automatically generate a prompt sentence for input to a generative AI model based on the goal information, the constraint information, and the obtained past normative information or past proposal information, the prompt sentence including a goal, conditions, and an output format,
input the prompt sentence to the generative AI model and obtain draft text information corresponding to the goal from the generative AI model, and convert the draft text information into display data and provide the display data to the terminal.

### Supplementary 2

The system according to supplementary 1,
wherein the processor is configured to
perform a consistency verification process on the draft text information obtained from the generative AI model by using the constraint information and the normative information stored in the similarity search storage, detect portions of the draft text information that contradict the existing normative information, and generate corrected draft text information by modifying or deleting the portions that contradict, and provide the corrected draft text information to the terminal.

### Supplementary 3

The system according to supplementary 1,
wherein the processor is configured to
obtain evaluation information or correction request information from the terminal operated by the user, update the structured data and the constraint information based on the evaluation information or the correction request information to generate updated constraint information,
regenerate the prompt sentence based on the updated constraint information, and cause the generative AI model to generate revised draft text information by inputting the regenerated prompt sentence to the generative AI model.

### Application Example 2

### Supplementary 1

A system comprising a processor,
wherein the processor is configured to
acquire rule information from an information storage device, perform language analysis processing and feature extraction processing on the rule information, generate semantic representations of the rule information, and store the semantic representations as learning data; and
obtain objective information input by a user and emotion information corresponding to the objective information, and construct a prompt sentence, based on the objective information and the emotion information, the prompt sentence including summary information of the rule information and rule information to be referenced and being for instructing a generative information processing model to generate a rule proposal or a policy proposal; and
input the prompt sentence and the summary information of the rule information to the generative information processing model, obtain the rule proposal or the policy proposal output from the generative information processing model, and divide the rule proposal or the policy proposal into component elements and store the component elements as a data structure; and
generate semantic representations for the respective component elements of the rule proposal or the policy proposal, perform similarity calculation and difference calculation by using the semantic representations and the semantic representations of the rule information, extract contradiction candidates between the rule proposal or the policy proposal and existing rule information, and generate correction information for correcting the rule proposal or the policy proposal so as to resolve the contradiction candidates; and
generate impact prediction information for predicting an impact degree of the rule proposal or the policy proposal based on the correction information and the emotion information, and,
when the impact prediction information conflicts with the emotion information and the objective information, reconstruct a prompt sentence for instructing the generative information processing model to generate an amendment proposal and obtain the amendment proposal; and
output the rule proposal or the policy proposal, the correction information, and the amendment proposal to a user terminal, obtain evaluation information or additional input information from the user terminal, and update the prompt sentence for the generative information processing model based on the evaluation information or the additional input information.

### Supplementary 2

The system according to supplementary 1,
wherein the processor is configured to generate the semantic representations of the rule information and the semantic representations of the rule proposal or the policy proposal as numerical data in a vector space, perform the similarity calculation and the difference calculation on the numerical data to extract the contradiction candidates, and input to the generative information processing model a prompt sentence including correction instructions for resolving the contradiction candidates to thereby obtain the correction information or the amendment proposal.

### Supplementary 3

The system according to supplementary 1,
wherein the processor is configured to
obtain the emotion information by performing emotion estimation processing on at least one of character string information, audio information, and image information of user input, and change, in accordance with the emotion information, at least one of expression intensity,
regulation strength, and conditions regarding support measures in the prompt sentence dynamically and input the prompt sentence to the generative information processing model so as to cause the generative information processing model to generate the rule proposal or the policy proposal and the amendment proposal reflecting an emotional state of the user.

What is claimed is:

1. A system comprising:
a communication interface coupled to a packet-switched network; and
circuitry configured to:
acquire reference information corresponding to a plurality of regions from a storage device via the communication interface, execute natural language processing on the acquired reference information to extract linguistic feature information, and store the linguistic feature information as an index structure;
train, based on the extracted linguistic feature information and the reference information, a generative neural network model to construct a trained model that represents contents and mutual relationships of the reference information;
generate, based on objective information received from a terminal device via the packet-switched network and the trained model, a prompt for instructing the generative neural network model to generate output data, input the prompt and contextual reference information to the generative neural network model, and acquire the output data;
compare the output data with the reference information based on the linguistic feature information and the trained model, detect inconsistent elements in the output data, and harmonize the output data by modifying the inconsistent elements; and
acquire evaluation information from the terminal device and retrain the generative neural network model based on the evaluation information to generate revised output data.

2. The system according to claim 1, wherein the circuitry is further configured to structure the acquired reference information into a normalized internal representation comprising segment identifiers, metadata fields, and logical relationships, and store the structured reference information in the storage device.

3. The system according to claim 2, wherein the natural language processing comprises tokenization, part-of-speech tagging, lemmatization, dependency parsing, and named-entity recognition, and wherein the index structure comprises an inverted index mapping terms and phrases to segment identifiers.

4. The system according to claim 3, wherein the circuitry is further configured to generate vector embeddings for segments of the reference information by passing tokenized segments through encoder layers of the trained model and applying pooling operations over hidden states, and to store the vector embeddings in a vector index data structure that supports approximate nearest neighbor queries.

5. The system according to claim 4, wherein the circuitry is further configured to encode the objective information into a query embedding using the trained model, perform a similarity search in the vector index data structure to retrieve relevant segments of the reference information, and combine semantic similarity search with keyword-based filtering using the index structure.

6. The system according to claim 5, wherein the reference information comprises regulation data associated with a plurality of jurisdictions, and wherein the relevant segments are filtered based on jurisdiction identifiers and topic classification labels.

7. The system according to claim 1, wherein the circuitry is further configured to construct the prompt by concatenating a role specification, the objective information, and summary information extracted from retrieved segments of the reference information into a structured template format.

8. The system according to claim 7, wherein the summary information is generated by a sequence-to-sequence model that produces abstractive summaries of retrieved segments, the sequence-to-sequence model being trained with an encoder-decoder architecture on segment-summary pairs.

9. The system according to claim 8, wherein the circuitry is further configured to apply a decoding algorithm comprising beam search or nucleus sampling to generate the output data, and to impose constraints comprising maximum length limits and repetition avoidance based on token and phrase pattern scoring.

10. The system according to claim 9, wherein the circuitry is further configured to divide the output data into component elements, generate semantic representations for each component element using the trained model, and store the semantic representations in association with component identifiers.

11. The system according to claim 1, wherein the circuitry detects the inconsistent elements by performing similarity calculation and difference calculation between semantic representations of component elements of the output data and semantic representations of the reference information in a vector space.

12. The system according to claim 11, wherein the difference calculation comprises vector subtraction and distance evaluation between component element vectors and reference information vectors, and wherein the circuitry identifies inconsistent elements when a distance metric exceeds a threshold.

13. The system according to claim 12, wherein the circuitry is further configured to generate correction information for the inconsistent elements by constructing a secondary prompt describing the detected inconsistency and instructing the generative neural network model to rewrite an affected component element.

14. The system according to claim 1, wherein the circuitry is further configured to obtain emotion information associated with the objective information by performing emotion estimation processing on input data received from the terminal device, and to incorporate the emotion information into the prompt.

15. The system according to claim 14, wherein the circuitry is further configured to generate impact prediction information based on the harmonized output data and the emotion information, determine whether the impact prediction information conflicts with the objective information and the emotion information, and when a conflict is determined, reconstruct the prompt to instruct the generative neural network model to generate an amendment to the output data.

16. The system according to claim 1, wherein the output data comprises a structured document including provisions organized as articles, sections, and clauses relating to normative rules for one or more jurisdictions.

17. The system according to claim 16, wherein the circuitry is further configured to perform a final consistency verification on amended portions of the output data by re-computing semantic representations and re-executing the similarity calculation against the reference information, and to output the verified output data, correction information, and impact prediction information to the terminal device.

18. A system comprising:
a communication interface coupled to a packet-switched network; and
circuitry configured to:
acquire reference information corresponding to a plurality of regions from a storage device, execute natural language processing comprising tokenization, dependency parsing, and named-entity recognition on the reference information to extract linguistic feature information, and store the linguistic feature information as an inverted index structure mapping terms and entity types to segment identifiers;
train a generative neural network model by performing machine learning processing based on the linguistic feature information and the reference information, the training comprising fine-tuning a transformer architecture using a masked language modeling objective and an optimization algorithm to construct a trained model encoding contents and mutual relationships of the reference information as vector embeddings;
receive objective information and emotion information from a terminal device via the packet-switched network, encode the objective information into a query embedding, perform approximate nearest neighbor search in a vector index to retrieve relevant segments, and generate summary information from the retrieved segments;
construct a prompt by assembling the objective information, the emotion information, and the summary information into a structured template format, input the prompt to the generative neural network model, and acquire generated output data;
divide the generated output data into component elements, generate semantic representations for each component element, perform similarity calculation and difference calculation between the component element representations and reference information representations to detect inconsistent elements, and generate correction information to harmonize the output data; and
generate impact prediction information based on the harmonized output data and the emotion information, and when the impact prediction information conflicts with the emotion information and the objective information, reconstruct the prompt to obtain an amendment to the output data from the generative neural network model.

19. The system according to claim 18, wherein the circuitry is further configured to acquire evaluation information from the terminal device, construct additional training examples from the evaluation information comprising positive and negative feedback labels associated with the generated output data, and retrain the generative neural network model using the additional training examples to reduce generation of inconsistent elements in subsequent output data.

20. A method comprising:
acquiring, by circuitry coupled to a packet-switched network, reference information corresponding to a plurality of regions from a storage device, executing natural language processing on the reference information to extract linguistic feature information, and storing the linguistic feature information as an index structure;
training, based on the linguistic feature information and the reference information, a generative neural network model to construct a trained model representing contents and mutual relationships of the reference information;
generating, based on objective information received from a terminal device via the packet-switched network and the trained model, a prompt for instructing the generative neural network model, inputting the prompt and contextual reference information to the generative neural network model, and acquiring output data;
comparing the output data with the reference information based on the linguistic feature information and the trained model, detecting inconsistent elements in the output data, and harmonizing the output data by modifying the inconsistent elements; and
acquiring evaluation information from the terminal device and retraining the generative neural network model based on the evaluation information to generate revised output data.
